(19) United States
(12) Patent Application Publication
(10) Pub. No.: US 2024/0062507 A1
(43) Pub. Date: Feb. 22, 2024

(54) INFORMATION PROCESSING DEVICE, INFORMATION PROCESSING SYSTEM, INFORMATION PROCESSING METHOD, AND RECORDING MEDIUM

(71) Applicant: NEC Corporation, Minato-ku, Tokyo (JP)

(72) Inventors: Florian Beye, Tokyo (JP); Yusuke Shinohara, Tokyo (JP); Hayato Itsumi, Tokyo (JP); Koichi Nihei, Tokyo (JP); Charvi Vitthal, Tokyo (JP); Takanori Iwai, Tokyo (JP)

(73) Assignee: NEC Corporation, Minato-ku, Tokyo (JP)

(21) Appl. No.: 18/271,642

(22) PCT Filed: Jan. 15, 2021
(86) PCT No.: PCT/JP2021/001240

§ 371 Date: Jul. 10, 2023

(51) Int. Cl. G06V 10/42; G06V 10/28

(52) U.S. Cl. CPC G06V 10/42; G06V 10/28

(57) ABSTRACT

An information processing device receives communication data based on feature data that indicates a feature of presented content of target data; restores the feature data on the basis of the received communication data; restores the target data on the basis of the restored feature data; performs a recognition process on the presented content of the target data on the basis of the restored feature data; and outputs information that indicates the presented content of the restored target data and a recognition result of the recognition process.

### TECHNICAL FIELD

The present invention relates to an information processing device, an information processing system, an information processing method, and a recording medium.

### BACKGROUND ART

In a remote monitoring system, (i) compression of video data at the transmitting side, (ii) transmission of the compressed video data from the transmitting side to the receiving side, (iii) restoration of the video data at the receiving side, and (iv) image recognition on the restored image may be performed.

For compression of video data, a deep learning-based video compression technique can be used (see Non-Patent Document 1 to Non-Patent Document 3). In image recognition, an object detection technique is used to detect and track a target (surveillance target) in an image (see Non-Patent Document 4). The target detection results can be displayed, for example, in the reconstructed image and presented to the observer.

### PRIOR ART DOCUMENTS

### Non Patent Documents

Non-Patent Document 1: Han et al., “Deep Generative Video Compression”, Neural Information Processing Systems (NIPS) 2019
Non-Patent Document 2: Lu et al., “DVC: An End-To-End Deep Video Compression Framework”, Computer Vision and Pattern Recognition (CVPR) 2019
Non-Patent Document 3: Rippel et al., “Learned Video Compression”, 2019 IEEE International Conference on Computer Vision (ICCV), 2019
Non-Patent Document 4: Lin et al., “Focal Loss for Dense Object Detection”, 2017 IEEE International Conference on Computer Vision (ICCV), 2017
Non-Patent Document 5: Kingma et al., “Glow: Generative Flow with Invertible 1×1 Convolutions”, Neural Information Processing Systems (NIPS) 2018

### SUMMARY OF THE INVENTION

### Problems to be Solved by the Invention

As described above, when video data is compressed and transmitted, the video is restored from the received data, and image recognition is performed on the reproduced image, in each step of video data compression, video restoration, and image recognition, delays due to processing time can occur. For real-time applications, such as remote monitoring or remote control, delays are significant. For example, when displaying on a restored image as a result of image recognition, it is conceivable that a delay would have a large adverse effect on QoE (Quality Of Experience, such as service).

An example of an object of the present invention is to provide an information processing device, an information processing system, an information processing method, and a recording medium capable of solving the above problem.

### Means for Solving the Problem

According to the first example aspect of the present invention, an information processing device includes reception means that receives communication data based on feature data that indicates a feature of presented content of target data; feature restoration means that restores the feature data on the basis of the received communication data; target restoration means that restores the target data on the basis of the restored feature data; recognition means that subjects the presented content of the target data to a recognition process on the basis of the restored feature data; and output means that outputs information that indicates the presented content of the restored target data and a recognition result of the recognition process.

According to the second example aspect of the present invention, an information processing system includes a transmission-side device and a reception-side device, the transmission-side device including data acquisition means that acquires target data; feature extraction means that calculates feature data indicating a feature of presented content of the target data; communication data generation means that generates communication data based on the feature data; and transmission means that transmits the communication data; and the reception-side device including reception means that receives the communication data; feature restoration means that restores the feature data on the basis of the received communication data; target restoration means that restores the target data on the basis of the restored feature data; recognition means that performs a recognition process on the presented content of the target data on the basis of the restored feature data; and output means that outputs information that indicates the presented content of the restored target data and a recognition result of the recognition process.

According to the third example aspect of the present invention, the information processing method includes receiving communication data based on feature data that indicates a feature of presented content of target data; restoring the feature data on the basis of the received communication data; restoring the target data on the basis of the restored feature data; performing a recognition process on the presented content of the target data on the basis of the restored feature data; and outputting information that indicates the presented content of the restored target data and a recognition result of the recognition process.

According to the fourth example aspect of the present invention, a recording medium is a recording median that records a program for causing a computer to execute: receiving communication data based on feature data that indicates a feature of presented content of target data; restoring the feature data on the basis of the received communication data; restoring the target data on the basis of the restored feature data; performing a recognition process on the presented content of the target data on the basis of the restored feature data; and outputting information that indicates the presented content of the restored target data and a recognition result of the recognition process.

### Effect of Invention

According to the present invention, the processing time for restoring target data and recognizing the content of the restored data can be relatively short.

### BRIEF DESCRIPTION OF THE DRAWINGS

FIG. 1 is a schematic block diagram showing a configuration example of the information processing system according to the first example embodiment.

FIG. 2 is a schematic block diagram showing a configuration example of the feature extraction unit according to the first example embodiment.

FIG. 3 is a schematic block diagram showing a configuration example of the processing stage unit according to the first example embodiment.

FIG. 4 is a schematic block diagram showing a configuration example of the processing block unit according to the first example embodiment.

FIG. 5 is a schematic block diagram showing a configuration example of the intermediate feature generation unit according to the first example embodiment.

FIG. 6 is a schematic block diagram showing a configuration example of the inverse processing stage unit according to the first example embodiment.

FIG. 7 is a schematic block diagram showing a configuration example of the inverse processing block unit according to the first example embodiment.

FIG. 8 is a schematic block diagram showing a configuration example of the acquired image restoration unit according to the first example embodiment.

FIG. 9 is a schematic block diagram showing a configuration example of the recognition unit according to the first example embodiment.

FIG. 10 is a flowchart showing an example of the processing procedure performed by the transmission-side device according to the first example embodiment.

FIG. 11 is a flowchart showing an example of the processing procedure performed by the reception-side device according to the first example embodiment.

FIG. 12 is a schematic block diagram showing a configuration example of the information processing system according to the second example embodiment.

FIG. 13 is a schematic block diagram showing a configuration example of the feature difference calculation unit according to the second example embodiment.

FIG. 14 is a schematic block diagram showing a configuration example of the difference processing stage unit according to the second example embodiment.

FIG. 15 is a schematic block diagram showing a configuration example of the difference processing block unit according to the second example embodiment.

FIG. 16 is a schematic block diagram showing a configuration example of the feature calculation unit according to the second example embodiment.

FIG. 17 is a schematic block diagram showing a configuration example of the restoration processing stage unit according to the second example embodiment.

FIG. 18 is a schematic block diagram showing a configuration example of the restoration processing block unit according to the second example embodiment.

FIG. 19 is a flowchart showing an example of the processing procedure performed by the transmission-side device according to the second example embodiment.

FIG. 20 is a flowchart showing an example of the processing procedure performed by the reception-side device according to the second example embodiment.

FIG. 21 is a schematic block diagram showing a first example of the configuration of the information processing system according to the third example embodiment.

FIG. 22 is a schematic block diagram showing a second example of the configuration of the information processing system according to the third example embodiment.

FIG. 23 is a schematic block diagram showing a third example of the configuration of the information processing system according to the third example embodiment.

FIG. 24 is a schematic block diagram showing a configuration example of the information processing device according to the fourth example embodiment.

FIG. 25 is a schematic block diagram showing a configuration example of the information processing system according to the fifth example embodiment.

FIG. 26 is a flowchart showing an example of the processing procedure in the information processing method according to the sixth example embodiment.

FIG. 27 is a schematic block diagram showing the configuration of a computer according to at least one example embodiment.

### EXAMPLE EMBODIMENT

Example embodiments of the present invention will be described hereinbelow, but the following example embodiments shall not limit the invention according to the claims. Also, not all combinations of features described in the example embodiments are essential for the solution of the invention.

A case where the information processing system transmits and receives image data and performs image recognition will be described below as an example. However, the target of transmission/reception and recognition processing in the following example embodiments is not limited to image data, and can be various data that can be compressed and decompressed (restored) in a hierarchical manner. For example, the information processing system may be used to transmit and receive voice data and perform voice recognition. Alternatively, the information processing system may use point cloud data output by various measurement devices such as LiDAR (Light Detection And Ranging) for transmission, reception, and recognition processing.

### First Example Embodiment

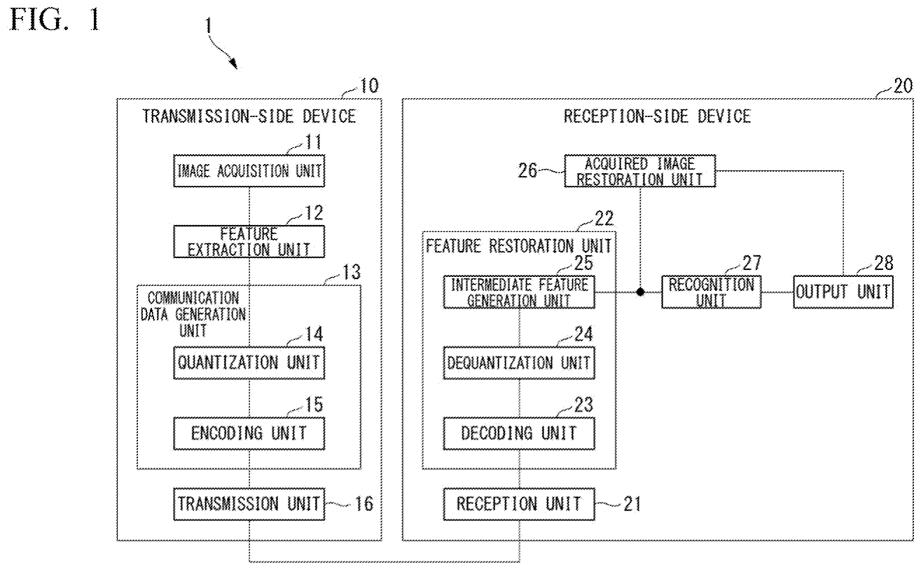

FIG. 1 is a schematic block diagram showing a configuration example of the information processing system according to the first example embodiment. In the configuration shown in FIG. 1, an information processing system 1 is provided with a transmission-side device 10 and a reception-side device 20. The transmission-side device 10 is provided with an image acquisition unit 11, a feature extraction unit 12, a communication data generation unit 13, and a transmission unit 16. The communication data generation unit 13 includes a quantization unit 14 and an encoding unit 15. The reception-side device 20 is provided with a reception unit 21, a feature restoration unit 22, an acquired image restoration unit 26, a recognition unit 27, and an output unit 28. The feature restoration unit 22 is provided with a decoding unit 23, a dequantization unit 24, and an intermediate feature generation unit 25.

The information processing system 1 performs image transmission and image recognition.

The transmission-side device 10 acquires an image, converts the acquired image into data for transmission such as a bit stream, and transmits the data to the reception-side device 20. The reception-side device 20 restores the image from the data received from the transmission-side device 10, and performs image recognition on the received image.

The information processing system 1 may be a remote monitoring system such as monitoring of an autonomously driven vehicle. The transmission-side device 10 may be installed at a monitoring point, while the reception-side device 20 may be installed at a location such as a data center away from the transmission-side device 10. The reception-side device 20 may detect or predict hazards in an autonomously driven vehicle by image recognition and report the hazards.

However, the use of the information processing system 1 is not limited to a specific use.

When an image is transmitted from the transmission-side device 10 to the reception-side device 20, feature extraction may be performed on the image to extract the features using a learning model, and feature data indicating the extracted features may be transmitted (after data conversion as necessary). Then, the reception-side device 20 may restore the image on the basis of the received feature data.

On the other hand, image feature extraction, image restoration from features, and image recognition all require a relatively large amount of computation. In applications that require real-time performance, such as remote monitoring, efficient processing in a short period of time is particularly required.

Therefore, the reception-side device 20 performs image recognition using intermediate feature data generated in the process of image restoration from the received data. Thereby, after the image is restored from the received data, the process can be performed more efficiently in a shorter time than in the case of performing image recognition using the restored image.

The reception-side device 20 corresponds to an example of an information processing device.

In the information processing system 1, the features of an image may be represented by vectors whose elements are real numbers. That is, the feature data indicating the features of the image may be represented in the form of feature vectors. A feature vector is also called a feature amount or a feature amount vector.

The image acquisition unit 11 acquires an image as image data. For example, the image acquisition unit 11 may be equipped with an imaging device such as a still camera or a video camera to capture moving or still images. When the image acquisition unit 11 captures a still image, for example, the capturing may be repeated at predetermined time intervals.

Alternatively, the imaging device may be configured as a device separate from the transmission-side device 10, and the image acquisition unit 11 may acquire image data from the imaging device. Alternatively, the image acquisition unit 11 may read the image data from the recording medium on which the image data is recorded.

The image acquisition unit 11 outputs the acquired image data to the feature extraction unit 12.

The data format of the image data acquired by the image acquisition unit 11 is not limited to a specific one. For example, the image acquisition unit 11 may acquire image data in the form of RGB pixel data, but is not limited thereto. The RGB pixel data format is an image data format in which red, green, and blue values are indicated for each pixel.

An image acquired by the image acquisition unit 11 is referred to as an acquired image. Image data representing an acquired image is referred to as acquired image data. Acquired image data corresponds to an example of target data. The acquired image corresponds to an example of the presented content of the target data.

The image acquisition unit 11 corresponds to an example of an acquisition means.

The feature extraction unit 12 performs feature extraction of the acquired image and generates feature data. Feature data is data representing visual features of an acquired image. “Visual” here refers to features relating to the display content of the image rather than the format of the image or file. As noted above, feature data may be presented in the form of real number vectors.

The feature extraction unit 12 corresponds to an example of a feature extraction means.

The feature extraction unit 12 may include a neural network model obtained using a deep learning technique. The neural network model in such a case may be an Invertible Neural Network (INN), which is a neural network that can be mathematically inverted.

However, the configuration of the feature extraction unit 12 is not limited to a specific configuration as long as it can generate feature data capable of restoring an acquired image. Generating feature data is also referred to as extracting features or extracting feature data. Generating feature data indicating features of an image of presented content of image data is also referred to as extracting feature data from image data.

A case in which the feature extraction unit 12 is configured using a deep learning model based on a convolutional neural network capable of inverse computation will be described below as an example. A deep learning model based on a convolutional neural network capable of performing inverse operations is also called an Invertible Deep Convolutional Neural Network Model. The inverse computation referred to here is an operation in which input and output are inverted from the original operation. That is, in an inverse operation, when the output value in the original operation becomes the input value to the inverse operation, the same value as the input value in the original operation is output.

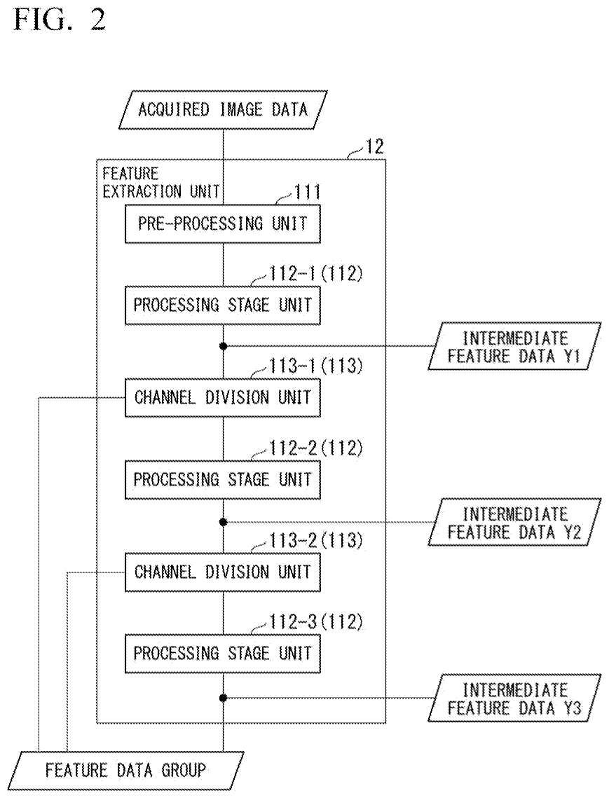

FIG. 2 is a schematic block diagram showing a configuration example of the feature extraction unit 12. In the configuration shown in FIG. 2, the feature extraction unit 12 is provided with a pre-processing unit 111, a processing stage unit 112, and a channel division unit 113.

In the example of FIG. 2, the feature extraction unit 12 is provided with three processing stage units 112 and two channel division units 113. These are connected in series in an arrangement in which one channel division unit 113 is provided between each of the two processing stage units 112, and further connected in series to the pre-processing unit 111. When distinguishing the three processing stage units 112, reference numerals 112-1, 112-2, and 112-3 are assigned in order from the upstream side to the downstream side of the data flow. When distinguishing between the two channel division units 113, reference numerals 113-1 and 113-2 are assigned in order from the upstream side to the downstream side of the data flow.

However, the number of processing stage units 112 included in the feature extraction unit 12 may be one or more. The number of channel division units 113 included in the feature extraction unit 12 may be one less than the number of processing stage units 112.

The pre-processing unit 111 performs pre-processing for feature extraction on the image data output by the image acquisition unit 11. For example, the pre-processing unit 111 may process the image so that the image size of the image data output by the image acquisition unit 11 is adjusted to match the image size accepted by the neural network constituting the feature extraction unit 12. The pre-processing unit 111 may also apply an image filter to the image data output by the image acquisition unit 11, such as a noise filter when the image output by the image acquisition unit 11 contains a lot of noise.

Alternatively, if the image data output by the image acquisition unit 11 can be directly input to the neural network for feature extraction, the feature extraction unit 12 does not need to be equipped with the pre-processing unit 111. That is, pre-processing by the pre-processing unit 111 is not essential.

The output of each of the processing stage units 112 is also referred to as intermediate features or intermediate feature data. The output of processing stage unit 112-1 is denoted as intermediate feature data Y1. The output of processing stage unit 112-2 is denoted as intermediate feature data Y2. The output of processing stage unit 112-3 is denoted as intermediate feature data Y3. Each piece of intermediate feature data corresponds to one type of feature data.

In the example of FIG. 2, the data that is channel-divided from the intermediate feature data also corresponds to one type of feature data.

Data in which a plurality of feature data are collected is also called a feature data group. In the example of FIG. 2, the data obtained by channel-dividing the intermediate feature data Y1, the data obtained by channel-dividing the intermediate feature data Y2, and the intermediate feature data Y3 are grouped together into a feature data group. The feature data group corresponds to one type of feature data. A feature data group is also referred to as feature data.

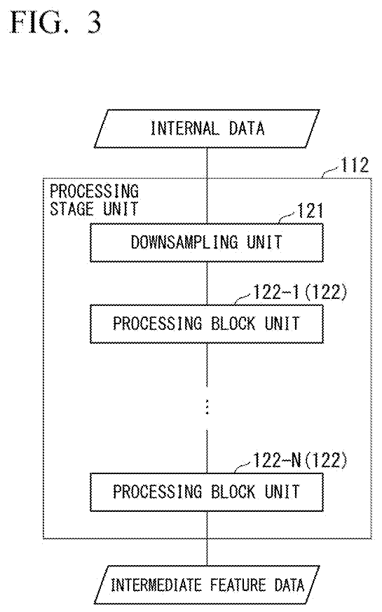

FIG. 3 is a schematic block diagram showing a configuration example of the processing stage unit 112. In the configuration shown in FIG. 3, the processing stage unit 112 is provided with a downsampling unit 121 and a processing block unit 122.

In the example of FIG. 3, the processing stage unit 112 is provided with N processing block units 122. These N processing block units 122 are connected in series and further connected to the downsampling unit 121 in series. When distinguishing between the N processing block units, reference numerals 122-1, . . . , 122-N are added in order from the upstream side to the downstream side of the data flow.

N may be an integer of 1 or more.

The downsampling unit 121 receives input of pixel-format data (data represented by an array of pixel values) and reduces the image size (the number of pixels) of the input data. Specifically, the input data to the downsampling unit 121 is preprocessed image data or pixel-format feature data (which is channel-divided data).

The method by which the downsampling unit 121 reduces the image size and the reduction ratio are not limited to a specific one.

For example, the downsampling unit 121 may reduce the image to one-quarter the number of pixels by replacing every four pixels, that is, two pixels vertically by two pixels horizontally, with one pixel. In that case, the downsampling unit 121 may select the maximum value among the pixel values of the four pixels. Alternatively, the downsampling unit 121 may calculate the average of the pixel values of four pixels and the average as the pixel value of the image after size reduction.

Alternatively, the number of output channels may be set to four times the number of input channels. Then, the downsampling unit 121 may assign each of the four pixels consisting of two pixels in the vertical direction by two pixels in the horizontal direction to different channels.

The number of input channels referred to here is the number of channels in the input data to the downsampling unit 121. The number of output channels is the number of channels in the output data from downsampling unit 121.

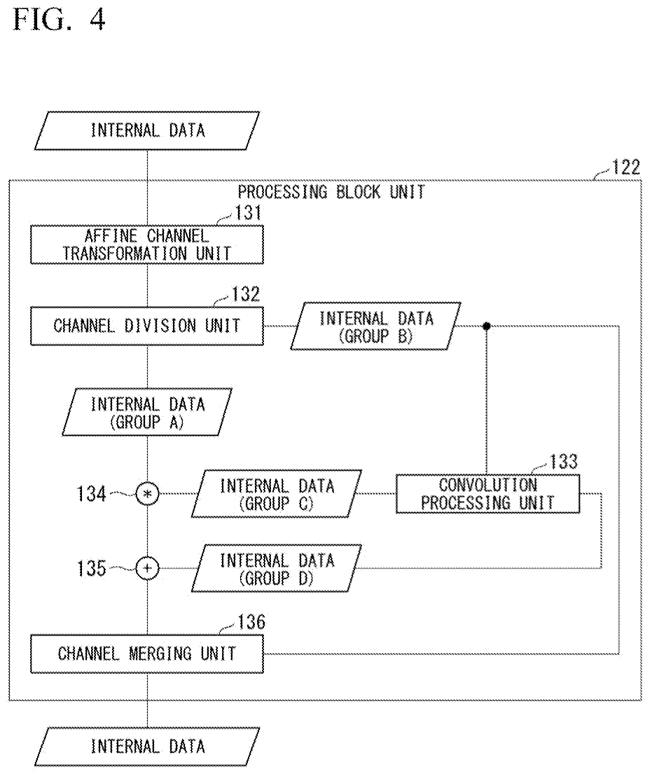

FIG. 4 is a schematic block diagram showing a configuration example of the processing block unit 122. In the configuration shown in FIG. 4, the processing block unit 122 is provided with an affine channel transformation unit 131, a channel division unit 132, a convolution processing unit 133, a multiplication unit 134, an addition unit 135, and a channel merging unit 136.

The affine channel transformation unit 131 corresponds to an affine layer in a convolutional neural network. Affine layers are also referred to as fully connected layers. The affine channel transformation unit 131 weights the input to the processing block unit 122. This weighting corresponds to the weighting of inputs to neuron models, which is commonly performed in neural networks. Note that the affine channel transformation unit 131 may perform processing using a 1×1 size filter.

The channel division unit 132 divides the output of the affine channel transformation unit 131 into channel-by-channel data. For example, the channel division unit 132 distributes each channel included in the output data of the affine channel transformation unit 131 to one of two groups, group A and group B. The channel division unit 132 outputs the channels assigned to group A to the multiplication unit 134, and outputs the channels assigned to group B to the convolution processing unit 133 and the channel merging unit 136.

Here, the term “channel” may refer to the feature data of each individual image. Channel division may be the allocation of feature data of individual images to one of a plurality of groups. For example, the output data of the affine channel transformation unit 131 may include feature data of a plurality of images, and feature data of individual images may be treated as channels. The channel division unit 132 may assign the feature data of individual images to any of a plurality of groups in the channel division.

The convolution processing unit 133 receives input of group B data (data assigned to group B) and performs convolution processing on the input data. The convolution processing unit 133 may perform a series of processes such as convolution processing and nonlinear transformation on the input data. The convolution processing unit 133 may be configured using a convolutional neural network.

The convolution processing unit 133 sorts the processed data into two groups, group C and group D. The convolution processing unit 133 outputs the data assigned to group C to the multiplication unit 134 and outputs the data assigned to group D to the addition unit 135.

The multiplication unit 134 receives the input of the data of group A and the data of group C, and multiplies the data of group A and the data of group C element by element. The data of group A and the data of group C have the same number of vertical elements and the same number of horizontal elements, and the multiplication unit 134 multiplies the element values for each element in the same position in the data of Group A and the data of Group C. The multiplication unit 134 outputs the data resulting from the multiplication to the addition unit 135.

The addition unit 135 receives the input of the data from the multiplication unit 134 and the data of group D, and adds the input data from the multiplication unit 134 and the data of group D together. Specifically, the addition unit 135 performs element-by-element addition of the data from the multiplication unit 134 and the data of group D. The data from the multiplication unit 134 and the data of group D have the same number of vertical elements and the number of horizontal elements, and the addition unit 135 adds the element values for each element in the same position in the data from the multiplication unit 134 and the data of Group D. The addition unit 135 outputs data of the addition result to the channel merging unit 136.

The channel merging unit 136 performs processing that is the reverse of the processing performed by the channel division unit 132. Thereby, the channel merging unit 136 connects one data from the addition unit 135 and one data of group B into a single piece of data. The inverse processing referred to here is processing corresponding to inverse calculation. The term “connecting” as used herein may mean bundling a plurality of pieces of data into one so as to be divisible.

Each of the channel division units 113 of the feature extraction unit 12 sorts each of the intermediate features output by the processing stage unit 112 into one of two groups. As a result, the channel division unit 113 extracts data for bundling into a feature data group as communication data to the reception-side device 20 from the intermediate feature data output by the processing stage unit 112. As noted above, a channel may be feature data for an individual image. Channel division may be the allocation of feature data of individual images to one of a plurality of groups.

By alternately providing the processing stage unit 112 and the channel division unit 113 as in the example of FIG. 2, the inverse processing of the processing by the processing stage unit 112 and the channel division unit 113 can be performed with a relatively simple calculation.

The communication data generation unit 13 generates communication data based on the feature data. Specifically, the communication data generation unit 13 converts the feature data group output by the feature extraction unit 12 into communication data.

The communication data generation unit 13 corresponds to an example of the communication data generation means.

The quantization unit 14 quantizes the feature data of the input image. The term quantization used here may refer to rounding from real numbers to integers (rounding off, rounding down, or rounding up). Therefore, the quantization of feature data performed by the quantization unit 14 is to convert each real number included in the feature data into an integer. A real number included in the feature data may be a further element of a real number vector that is an element of the feature data.

The quantization unit 14 corresponds to an example of a quantization means.

The encoding unit 15 performs entropy encoding on the quantized feature data. Entropy encoding here refers to the process of data transformation (encoding) to minimize information entropy based on the predicted probability distribution of input data (input code). A known entropy encoding algorithm can be used for the processing performed by the encoding unit 15.

The encoding unit 15 converts the feature data into a bit stream (a data stream represented by a sequence of bits) using entropy encoding.

However, the encoding method used by the information processing system 1 is not limited to entropy encoding. Various encoding methods that can generate data suitable for communication, such as bitstreams, can be applied to the information processing system 1.

Neither the quantization performed by the quantization unit 14 nor the encoding performed by the encoding unit 15 is limited to specific processing. Any combination of these processes can be used to transform the feature data into a bitstream for transmission.

The transmission unit 16 transmits the communication data. Specifically, the transmission unit 16 transmits the bitstream output by the encoding unit 15 to the reception unit 21 of the reception-side device 20 as a communication signal. The transmission unit 16 corresponds to an example of a transmission means.

The communication method between the transmission unit 16 and the reception unit 21 is not limited to any specific one. For example, the transmission unit 16 and the reception unit 21 may communicate wirelessly or may communicate using wired communication.

The reception unit 21 receives communication data based on feature data of the acquired image. Specifically, the reception unit 21 receives a signal from the transmission unit 16 and restores the bitstream.

The reception unit 21 corresponds to an example of a reception means.

The feature restoration unit 22 restores feature data based on the communication data received by the reception unit 21.

The feature restoration unit 22 corresponds to an example of a feature restoration means.

The decoding unit 23 converts the bitstream into quantized feature data by entropy decoding. The decoding performed by the decoding unit 23 corresponds to the inverse calculation of the encoding performed by the encoding unit 15.

As described above, the encoding scheme used by the information processing system 1 is not limited to entropy encoding. The decoding performed by the reception-side device 20 is not limited to entropy decoding, and may be decoding of data encoded by the transmission-side device 10.

The dequantization unit 24 dequantizes the quantized feature data acquired by the decoding unit 23. Specifically, the dequantization unit 24 converts each integer included in the feature data into a real number.

The method by which the dequantization unit 24 converts integers to real numbers is not limited to a specific method. For example, the dequantization unit 24 may store in advance a probability distribution representing the encoding probability of real vectors as elements of feature data, and perform sampling based on this probability distribution. In this case, the probability distribution representing the encoding probability of real vectors as elements of feature data corresponds to an example of the probability distribution of feature data before quantization.

It is expected that the dequantization unit 24 can perform dequantization with high accuracy by reflecting the probability distribution of the feature data in the dequantization.

Alternatively, the dequantization unit 24 may leave the integer values as they are and change only the data format, from integer data to real number data.

The dequantization unit 24 corresponds to an example of a dequantization means.

Ideally, the dequantization performed by the dequantization unit 24 is the inverse operation of the quantization performed by the quantization unit 14, but usually the pre-quantized values at the transmission side cannot always be accurately recovered at the reception side. It is considered that the feature data after dequantization by the dequantization unit 24 also contains quantization noise (quantization error). Quantization noise is the error resulting from quantization and dequantization. When indicating that quantization noise is included, “noisy” is added to the terminology, such as “noisy feature data” and “noisy intermediate feature data.”

When the size of the real number included in the feature data is large relative to the size of the rounding in quantization, the impact of the quantization noise in the noisy feature data on the restoration of the received image and image recognition by the reception-side device 20 is small. When precision is required for the processing of the reception-side device 20, the magnitude of the real number included in the feature data may be increased according to the required precision. Increasing the magnitude of the real number included in the feature data is performed, for example, by increasing the upper limit of the pixel value in the acquired image and expressing the pixel value with a large value.

Dequantization by the dequantization unit 24 can be regarded as an approximate inverse operation to the quantization by the quantization unit 14.

The intermediate feature generation unit 25 calculates noisy intermediate feature data from the noisy feature data group output by the dequantization unit 24. The operations of the intermediate feature generation unit 25 are ideally the inverse operations of the operations of the feature extraction unit 12, but are not limited thereto. The intermediate feature generation unit 25 should be able to calculate noisy intermediate feature data with the accuracy required according to the application of the information processing system 1.

In the following, the intermediate feature generation unit 25 is configured using a deep learning model based on a convolutional neural network capable of inverse computation, with an example being given in which the intermediate feature generation unit 25 is the inverse model of the channel division unit 113-1, the processing stage unit 112-2, the channel division unit 113-2, and the processing stage unit 112-3 portions of the feature extraction unit 12. The inverse model referred to here is a model that performs inverse operations. In other words, the following is an example of a case in which the intermediate feature generation unit 25 performs the inverse operation to the operation by the above portion of the feature extraction unit 12.

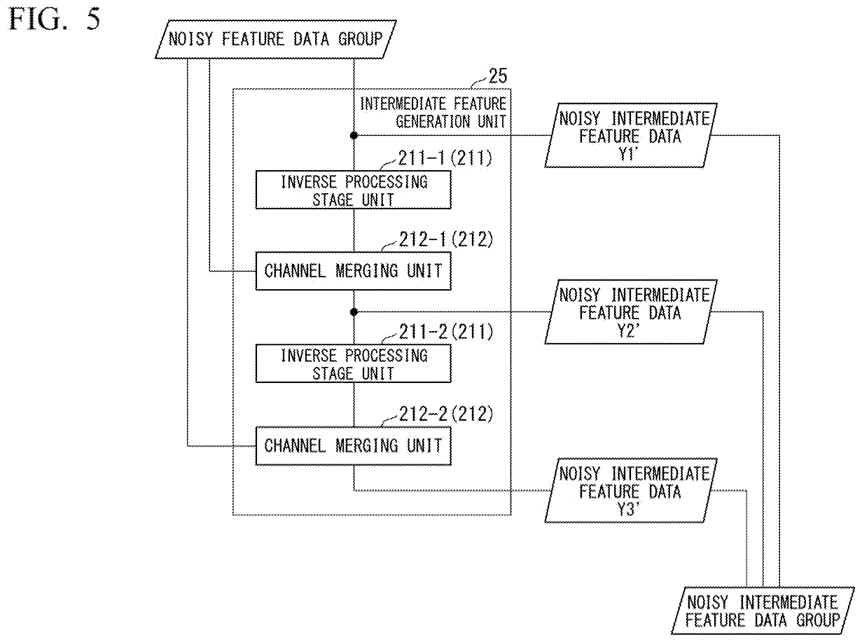

FIG. 5 is a schematic block diagram showing a configuration example of the intermediate feature generation unit 25. In the configuration shown in FIG. 5, the intermediate feature generation unit 25 is provided with an inverse processing stage unit 211 and a channel merging unit 212.

In the example of FIG. 5, two inverse processing stage units 211 and two channel merging units 212 are alternately arranged and connected in series. When distinguishing between the two inverse processing stage units 211, reference numerals 211-1 and 211-2 are assigned in order from the upstream side to the downstream side of the data flow. When distinguishing between the two channel merging units 212, reference numerals 212-1 and 212-2 are assigned in order from the upstream side to the downstream side of the data flow.

Each inverse processing stage unit 211 performs an inverse operation of the operation of one processing stage unit 112. The inverse processing stage unit 211-1 performs the inverse operation of the operation of the processing stage unit 112-3. The inverse processing stage unit 211-2 performs the inverse operation of the operation of the processing stage unit 112-2.

In the example of FIG. 5, the noisy feature data group input to the intermediate feature generation unit 25 includes noisy intermediate feature data Y1′. The noisy intermediate feature data Y1′ is data obtained by restoring the intermediate feature data Y3 output from the processing stage unit 112-3 (FIG. 2) including quantization noise.

The output of the channel merging unit 212-1 is denoted as noisy intermediate feature data Y2′. The noisy intermediate feature data Y2′ is data obtained by restoring the intermediate feature data Y2 output from the processing stage unit 112-2 including quantization noise.

The output of the channel merging unit 212-2 is denoted as noisy intermediate feature data Y3′. The noisy intermediate feature data Y3′ is data obtained by restoring the intermediate feature data Y1 output from the processing stage unit 112-1 including quantization noise.

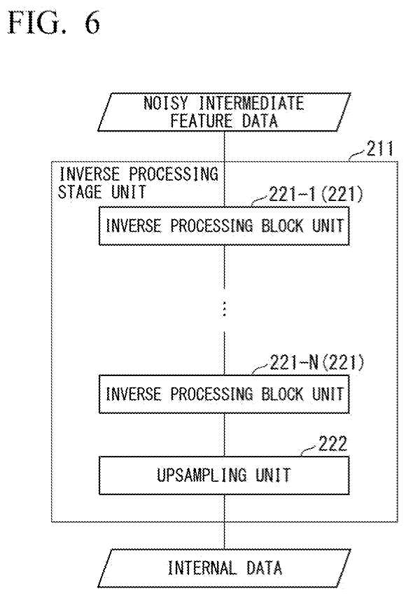

FIG. 6 is a schematic block diagram showing a configuration example of the inverse processing stage unit 211. In the configuration shown in FIG. 6, the inverse processing stage unit 211 is provided with an inverse processing block unit 221 and an upsampling unit 222.

In the example of FIG. 6, N inverse processing block units 221 are connected in series, and the upsampling unit 222 is also connected in series. When distinguishing the N inverse processing block units 221, reference numerals 221-1, . . . , 222-N are added in order from the upstream side to the downstream side of the data flow.

Each inverse processing block unit 221 performs the inverse operation of the operation of one processing block unit 122. The inverse processing block units 221-1, . . . , 221-N perform the inverse operation of the operations of the processing block units 122-N, . . . , 122-1, respectively.

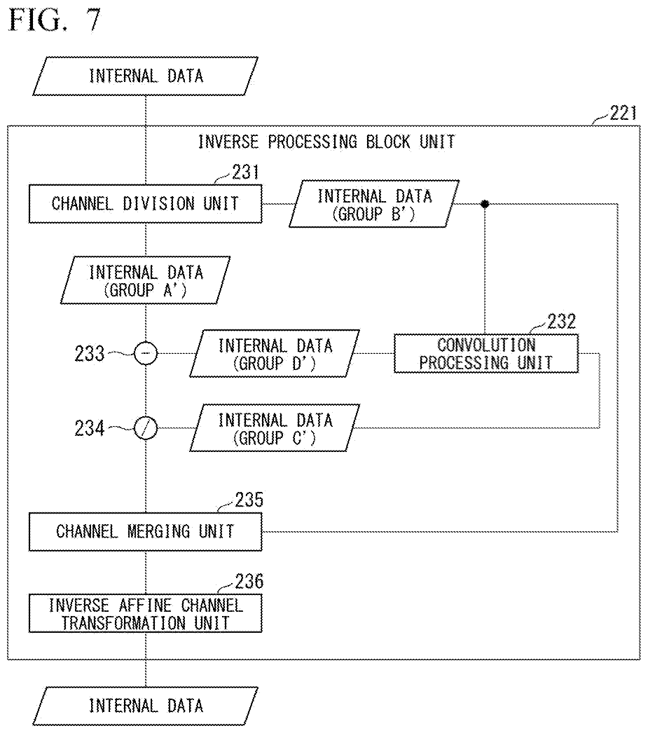

FIG. 7 is a schematic block diagram showing a configuration example of the inverse processing block unit 221. In the configuration shown in FIG. 7, the inverse processing block unit 221 is provided with a channel division unit 231, a convolution processing unit 232, a subtraction unit 233, a division unit 234, a channel merging unit 235, and an inverse affine channel transformation unit 236.

The channel division unit 231 performs the inverse operation of the operation performed by the channel merging unit 136. Thereby, the channel division unit 231 performs the same processing as the channel division unit 132. For example, the channel division unit 231 allocates each channel included in the input data to the channel division unit 231 itself to one of two groups, Group A′ and Group B′, similar to the channel division unit 132. Group A′ is a group corresponding to Group A. Group B′ is a group corresponding to group B.

The channel division unit 231 outputs the data allocated to the group A′ to the subtraction unit 233 and outputs the data allocated to the group B′ to the convolution processing unit 232 and the channel merging unit 235.

The combination of the convolution processing unit 232, the subtraction unit 233, and the division unit 234 performs the inverse operation of the operation performed by the combination of the convolution processing unit 133, the multiplication unit 134, and the addition unit 135.

The convolution processing unit 232 performs processing similar to that of the convolution processing unit 133. Specifically, the convolution processing unit 232 receives the input of data of group B′ and performs convolution processing on the input data. When the convolution processing unit 133 performs a series of processes such as convolution processing and nonlinear transformation on the input data, the convolution processing unit 232 also performs a series of processes similar to the convolution processing unit 133. The convolution processing unit 232 may be configured using a convolutional neural network.

The convolution processing unit 232 sorts the processed data into two groups, group C′ and group D′. Group C′ is a group corresponding to group C. Group D′ is a group corresponding to group D.

The convolution processing unit 232 outputs the data assigned to group D′ to the subtraction unit 233 and outputs the data assigned to group C′ to the division unit 234.

The subtraction unit 233 performs the inverse operation of the addition unit 135. Specifically, the subtraction unit 233 receives the input of the data of group A′ and the data of group D′, and subtracts the data of group D′ from the input data of group A′. More specifically, the subtraction unit 233 subtracts the value of an element of the data of group D′ from the value of an element of the data of group A′ for each element of the data of group A′ and the data of group D′. The data of group A′ and the data of group D′ have the same number of vertical elements and the same number of horizontal elements, and the subtraction unit 233 subtracts the value of the element of data in group D′ from the value of the element of data in group A′ for each element in the same position in the data of Group A′ and the data of Group D′. The subtraction unit 233 outputs the subtraction result data to the division unit 234.

The division unit 234 performs the inverse operation of the multiplication unit 134. Specifically, the division unit 234 receives the input of the data from the subtraction unit 233 and the data of the group C′, and divides the element values of the data from the subtraction unit 233 by the element values of the data from group C′ for each element of the data from the subtraction unit 233 and group C′. The data from the subtraction unit 233 and the data of the group C′ have the same number of vertical elements and the same number of horizontal elements, and the division unit 234 divides the element value of the data from the subtraction unit 233 by the element value of the data in group C′ for each element in the same position as the data from the subtraction unit 233 and the data in group C′. The division unit 234 outputs data of the division result to the channel merging unit 235.

The channel merging unit 235 performs processing that is the reverse of the processing performed by the channel division unit 231. Thereby, the channel merging unit 235 bonds one data from the division unit 234 and one data of group B′ into a single piece of data.

The processing of the channel merging unit 235 also corresponds to the inverse processing of the processing performed by the channel division unit 132.

The inverse affine channel transformation unit 236 performs the inverse operation of the affine channel transformation unit 131.

Ideally, the upsampling unit 222 of the inverse processing stage unit 211 performs the inverse operation of the operation of the downsampling unit 121. However, there may be cases where the data before downsampling on the transmitting side cannot always be restored accurately on the receiving side. For example, consider the case where the downsampling unit 121 replaces four pixels with one pixel having a pixel value that is the average of the pixel values of the four pixels, as described above. In this case, the upsampling unit 222 cannot normally calculate the original four pixel values from the one obtained pixel value.

Therefore, the upsampling unit 222 may approximately restore the data before downsampling. For example, the upsampling unit 222 may divide each pixel of the input data into four pixels of 2 vertical by 2 horizontal, and set the value of each pixel to the same value as that of the original pixel, thereby converting the data (image data or feature data) to image data of four times the size.

The channel merging unit 212 of the intermediate feature generation unit 25 performs the inverse operation of the operation performed by the channel division unit 113. As a result, the channel merging unit 212 generates data in which a plurality of channels are combined. The channel merging unit 212-1 performs the inverse operation to the operation of the channel division unit 113-2. The channel merging unit 212-2 performs the inverse operation to the operation of the channel division unit 113-1.

The acquired image restoration unit 26 calculates an image based on the intermediate feature data output by the intermediate feature generation unit 25. Specifically, the acquired image restoration unit 26 restores the acquired image by performing inverse processing to the processing of the pre-processing unit 111 and the processing stage unit 112-1, among the processing of the feature extraction unit 12. The image calculated by the acquired image restoration unit 26 is also referred to as a restored image.

The acquired image restoration unit 26 corresponds to an example of the target restoration means. Restoration of the acquired image by the acquired image restoration unit 26 corresponds to the processing for restoring the acquired image data based on the feature data restored by the feature restoration unit 22.

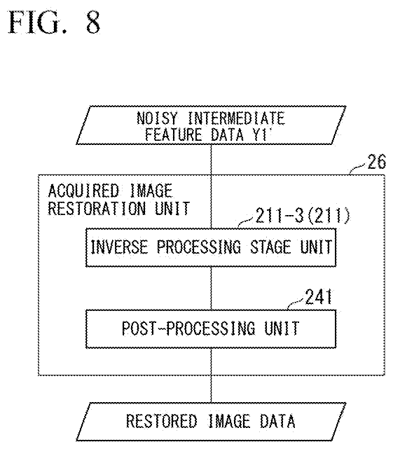

FIG. 8 is a schematic block diagram showing a configuration example of the acquired image restoration unit 26. In the configuration shown in FIG. 8, the acquired image restoration unit 26 is provided with the inverse processing stage unit 211 and the post-processing unit 241.

To distinguish the inverse processing stage unit 211 of the acquired image restoration unit 26 from the inverse processing stage unit of the intermediate feature generation unit 25 (FIG. 5), the inverse processing stage unit 211 of the acquired image restoration unit 26 is denoted as the inverse processing stage unit 211-3. The inverse processing stage unit 211-3 corresponds to the inverse model of the processing stage unit 112-1 (FIG. 2).

The post-processing unit 241 performs the inverse operation of the operation of the pre-processing unit 111.

The reconstructed image resembles the acquired image. Specifically, the restored image is an image obtained by adding quantization noise to the acquired image.

The recognition unit 27 performs image recognition based on the noisy intermediate feature data group output by the intermediate feature generation unit 25. The noisy intermediate feature data group output by the intermediate feature generation unit 25 corresponds to the feature data of the restored image. Image recognition performed by the recognition unit 27 corresponds to image recognition on the restored image. Image recognition on the restored image can be said to be image recognition on the acquired image, which is the original image of the restored image.

Therefore, the image recognition performed by the recognition unit 27 corresponds to performing recognition processing on the acquired image, which is the presented content of the acquired image data, based on the feature data restored by the feature restoration unit 22. The recognition unit 27 corresponds to an example of a recognition means.

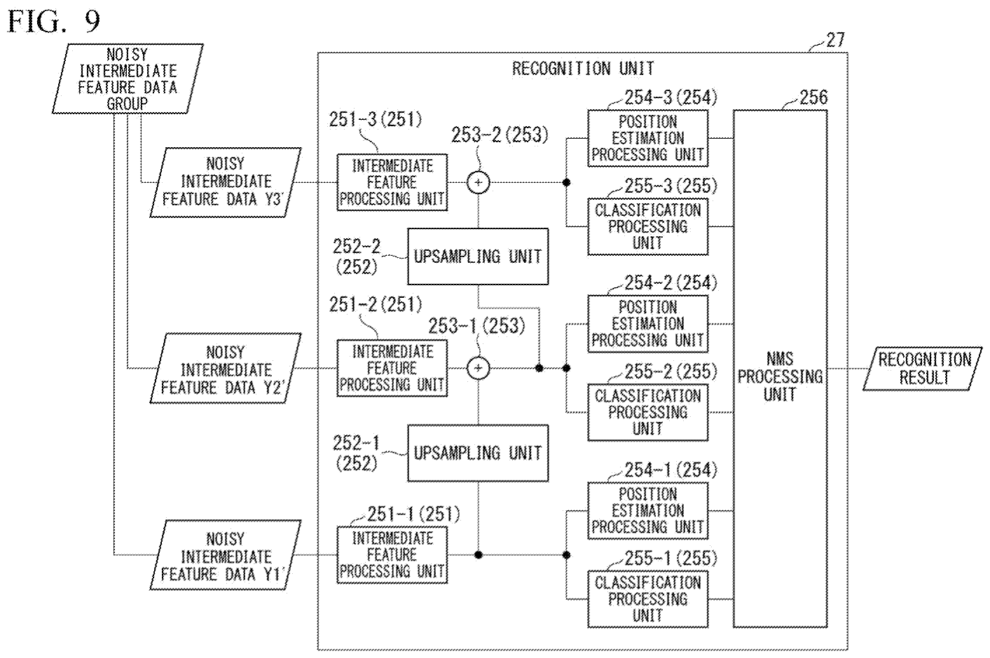

FIG. 9 is a schematic block diagram showing a configuration example of the recognition unit 27. In the configuration shown in FIG. 9, the recognition unit 27 is provided with an intermediate feature processing unit 251, an upsampling unit 252, an addition unit 253, a position estimation processing unit 254, a classification processing unit 255, and an NMS (Non-Maximum Suppression) processing unit 256.

In the example of FIG. 9, one position estimation processing unit 254 and one classification processing unit 255 are connected to each of the three intermediate feature processing units 251.

Also, the output of the first intermediate feature processing unit 251 is input to the first upsampling unit 252, and the output of the upsampling unit 252 and the output of the second intermediate feature processing unit 251 are added pixel by pixel by the first addition unit 253. The data after the addition is input to the second upsampling unit 252, and the output of the upsampling unit 252 and the output of the third intermediate feature processing unit 251 are added pixel by pixel by the second addition unit 253.

When distinguishing between the three intermediate feature processing units 251, the first intermediate feature processing unit 251 is referred to as the intermediate feature processing unit 251-1. The second intermediate feature processing unit 251 is referred to as the intermediate feature processing unit 251-2. The third intermediate feature processing unit 251 is referred to as the intermediate feature processing unit 251-3.

When distinguishing between the three position estimation processing units 254, the position estimation processing unit 254 connected to the intermediate feature processing unit 251-1 is referred to as the position estimation processing unit 254-1. The position estimation processing unit 254 connected to the intermediate feature processing unit 251-2 is referred to as the position estimation processing unit 254-2. The position estimation processing unit 254 connected to the intermediate feature processing unit 251-3 is referred to as the position estimation processing unit 254-3.

When distinguishing between the three classification processing units 255, the classification processing unit 255 connected to the intermediate feature processing unit 251-1 is referred to as the classification processing unit 255-1. The classification processing unit 255 connected to the intermediate feature processing unit 251-2 is referred to as the classification processing unit 255-2. The classification processing unit 255 connected to the intermediate feature processing unit 251-3 is referred to as the classification processing unit 255-3.

When distinguishing between the two upsampling units 252, the upsampling unit 252 to which the output of the intermediate feature processing unit 251-1 is input is referred to as the upsampling unit 252-1. The upsampling unit 252 to which the output of the intermediate feature processing unit 251-2 is input is referred to as the upsampling unit 252-2.

When distinguishing between the two addition units 253, the addition unit 253 that adds the output of the intermediate feature processing unit 251-2 and the output of the upsampling unit 252-1 is referred to as the addition unit 253-1. The addition unit 253 that adds the output of intermediate feature processing unit 251-3 and the output of the upsampling unit 252-2 is referred to as the addition unit 253-2.

Each intermediate feature processing unit 251 detects a recognition target in the noisy intermediate feature included in the noisy intermediate feature data. There may be a case where the intermediate feature processing unit 251 does not detect even one recognition target. Also, one intermediate feature processing unit 251 may detect a plurality of recognition targets.

A known method can be used as the method by which the intermediate feature processing unit 251 detects a recognition target.

Each of the upsampling units 252 performs the same processing as the upsampling unit 222 (FIG. 6) of the inverse processing stage unit 211. The upsampling unit 252 restores the data before downsampling by the downsampling unit 121, as in the case of the upsampling unit 222. The upsampling unit 252 may approximately restore the data before downsampling by the downsampling unit 121.

Each addition unit 253 adds the output of the intermediate feature processing unit 251 and the output of the upsampling unit 252 pixel by pixel.

Each of the position estimation processing units 254 estimates the position in the restored image of the recognition target detected by the intermediate feature processing unit 251.

A known method can be used as the method by which the position estimation processing unit 254 detects the position in the restored image of the recognition target.

The classification processing unit 255 classifies the recognition targets detected by the intermediate feature processing unit 251 into classes. This class classification may be an estimation of the type of recognition target.

A known method can be used as the method by which the classification processing unit 255 classifies recognition targets.

When areas recognized as the same class overlap on the image (here, on the restored image), the NMS processing unit 256 eliminates the overlap. The NMS processing unit 256 may leave any one of the overlapping areas of the same class and delete the others. Alternatively, the NMS processing unit 256 may replace the overlapping regions with a single region that encompasses those regions.

As the method by which the NMS processing unit 256 performs processing, a method known as Non-Maximum Suppression may be used.

The output unit 28 outputs information indicating the restored image generated by the acquired image restoration unit 26 and the recognition result by the recognition unit 27. For example, the output unit 28 may include a display device to display the restored image. Then, the output unit 28 may indicate the recognition target in the restored image by surrounding it with a bounding box (a rectangle that exactly surrounds the area), and indicate the class of the recognition target with the color of the bounding box.

However, the method by which the output unit 28 outputs the restored image and the recognition result is not limited to a specific method.

The output unit 28 may output the restored image and the recognition result separately.

The output unit 28 corresponds to an example of an output means.

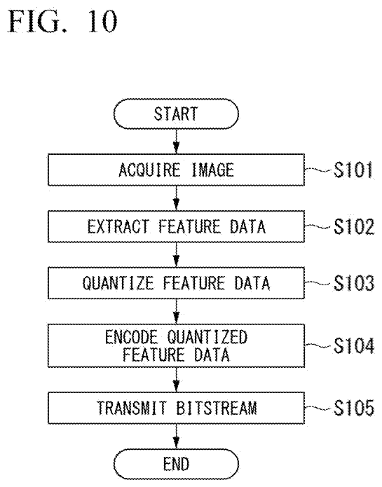

FIG. 10 is a flowchart showing an example of the processing procedure performed by the transmission-side device 10. The transmission-side device 10 may repeat the processing of FIG. 10. For example, when the transmission-side device 10 repeats the acquisition of still images at a predetermined cycle, the process of FIG. 10 may be performed each time a still image is acquired.

In the process of FIG. 10, the image acquisition unit 11 acquires an image (Step S101). As described above, the image acquired by the image acquisition unit 11 is also referred to as an acquired image.

Next, the feature extraction unit 12 extracts feature data of the acquired image (Step S102).

Next, the quantization unit 14 quantizes the feature data (Step S103).

Next, the encoding unit 15 encodes the quantized feature data (Step S104). The encoding unit 15 converts the quantized feature data into a bitstream by encoding the quantized feature data.

Then, the transmission unit 16 transmits the bitstream output from the encoding unit 15 to the reception-side device 20 (Step S105).

After Step S105, the transmission-side device 10 ends the processing of FIG. 10.

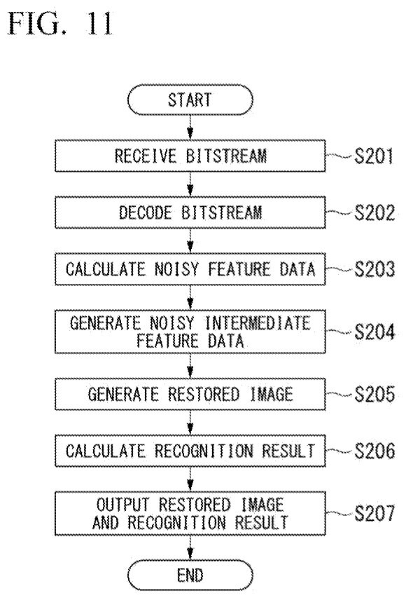

FIG. 11 is a flowchart showing an example of the processing procedure performed by the reception-side device 20. The reception-side device 20 may repeat the processing in FIG. 11 in accordance with the repetition of the processing in FIG. 10 by the transmission-side device 10.

In the process of FIG. 11, the reception unit 21 receives a bitstream (Step S201).

Next, the decoding unit 23 decodes the bitstream received by the reception unit 21 (Step S202). As described above, the decoding unit 23 performs decoding by the inverse operation of the encoding performed by the encoding unit 15 of the transmission-side device 10. The decoding unit 23 generates quantized feature data by decoding the bitstream.

Next, the dequantization unit 24 calculates noisy feature data by dequantizing the data obtained by decoding the bitstream in Step S202 (Step S203). As described above, the noisy feature data can be said to be the feature data extracted by the feature extraction unit 12 with quantization noise added.

Next, the intermediate feature generation unit 25 generates noisy intermediate feature data based on the noisy feature data (Step S204).

The acquired image restoration unit 26 generates a restored image based on the noisy intermediate feature data (Step S205).

The recognition unit 27 also performs image recognition based on the noisy intermediate feature data, and calculates a recognition result (Step S206).

Then, the output unit 28 outputs the restored image and the recognition result (Step S207).

After Step S207, the reception-side device 20 ends the processing of FIG. 11.

As described above, the reception unit 21 receives the communication data based on the feature data indicating the features of the acquired image, which is the presented content of the acquired image data. The feature restoration unit 22 restores the feature data based on the received communication data. The acquired image restoration unit 26 restores the acquired image data based on the restored data. The recognition unit 27 performs image recognition on the acquired image, which is the presented content of the acquired image data, based on the restored feature data. The output unit 28 outputs information indicating the restored presented content of the target data and the recognition result of the recognition processing.

In this way, the reception-side device 20 uses the feature data restored by the feature restoration unit 22 for both the restoration of the acquired image by the acquired image restoration unit 26 and the image recognition by the recognition unit 27. According to the reception-side device 20, in comparison with the case where image recognition is performed using the restored image after restoring the image, the processing time for performing the restoration process of the acquired image data and image recognition on the restored image, which is the presented content of the restored data, can be shortened.

The reception unit 21 also receives communication data based on the quantized feature data. The dequantization unit 24 performs dequantization on the quantized feature data based on sampling according to the probability distribution of the feature data before quantization.

It is expected that the dequantization unit 24 can perform dequantization with high accuracy by reflecting the probability distribution of the feature data in the dequantization.

The reception unit 21 also receives communication data based on the intermediate feature data Y1 and the intermediate feature data Y2 calculated based on data downsampled by the downsampling unit 121 from the intermediate feature data Y1. The feature restoration unit 22 restores the noisy intermediate feature data Y3′ based on the data upsampled by the upsampling unit 222 from the noisy intermediate feature data Y2′, which is obtained by restoring the intermediate feature data Y2 based on the received communication data.

In this manner, the reception-side device 20 restores the acquired image data using the feature data of different image sizes, which makes it relatively easy to adjust the compression ratio of the image at the transmission-side device 10.

The feature restoration unit 22 restores the intermediate feature data Y1 using a process that corresponds to the inverse operation of the process in which the processing stage unit 112 calculates the intermediate feature data Y2 based on the data downsampled from the intermediate feature data Y1.

As a result, it is expected that the feature restoration unit 22 can restore the intermediate feature data with relatively high accuracy.

### Second Example Embodiment

FIG. 12 is a schematic block diagram showing a configuration example of the information processing system according to the second example embodiment. In the configuration shown in FIG. 2, an information processing system 2 is provided with a transmission-side device 30 and a reception-side device 40. The transmission-side device 30 is provided with an image acquisition unit 11, a feature extraction unit 12, a communication data generation unit 31, a transmission unit 16, and a noisy feature data storage unit 35. The communication data generation unit 31 is provided with a quantization unit 14, an encoding unit 15, a dequantization unit 32, a feature difference calculation unit 33, and a feature calculation unit 34. The reception-side device 20 is provided with the reception unit 21, a feature restoration unit 41, the acquired image restoration unit 26, the recognition unit 27, the output unit 28, and a noisy feature data storage unit 43. The feature restoration unit 41 is provided with the decoding unit 23, the dequantization unit 24, the intermediate feature generation unit 25, and a feature calculation unit 42.

In FIG. 12, the same reference numerals (11, 12, 14, 15, 16, 21, 23, 24, 25, 26, 27, 28) are attached to those portions having similar functions corresponding to the portions in FIG. 1, and detailed descriptions thereof are omitted here.

Comparing the configuration of the information processing system 2 shown in FIG. 12 with the information processing system 1 shown in FIG. 1, functional units for efficiently transmitting and processing moving images are added. Otherwise, the information processing system 2 is the same as the information processing system 1.

In the second example embodiment, the image acquisition unit 11 acquires a video image or still images that are repeatedly imaged at a relatively short period such as a one-second period. When the image acquisition unit 11 acquires a video image, the data of each frame of the video image is treated as acquired image data.

One of the acquired image data is referred to as first acquired image data, and the data of the acquired image captured after the first acquired image is referred to as second acquired image data. The first acquired image data corresponds to an example of first target data. The second acquired image data corresponds to an example of second target data.

The feature extraction unit 12 calculates feature data for each of a plurality of images (frames of a video image when the image acquisition unit 11 acquires a video image) acquired by the image acquisition unit 11. For example, the feature extraction unit 12 extracts first feature data from the first acquired image data, and extracts second feature data from the second acquired image data.

For the first image acquired by the image acquisition unit 11, the communication data generation unit 31 converts the feature data (for example, a feature data group) of the image into communication data, similarly to the communication data generation unit 13 of the first example embodiment.

On the other hand, the communication data generation unit 31 calculates feature difference data for the second and subsequent images acquired by the image acquisition unit 11, and generates communication data based on the calculated feature difference data. The feature difference data is data indicating the difference between two feature data calculated by the feature extraction unit 12. For example, the communication data generation unit 31 calculates feature difference data indicating a difference between the first feature data and the second feature data, and generates communication data based on the calculated feature difference data.

In particular, the communication data generation unit 31 generates noisy feature difference data including quantization noise by quantization in the quantization unit 14 and dequantization in the dequantization unit 32, and generates communication data based on the noisy feature difference data.

The dequantization unit 32 performs the same processing as the dequantization unit 24 of the reception-side device 40. Thereby, the dequantization unit 32 generates the same noisy feature data as the noisy feature data generated by the dequantization unit 24.

The noisy feature data storage unit 35 temporarily stores the noisy feature data. The noisy feature data stored in the noisy feature data storage unit 35 is used for generating noisy feature difference data in the next process. Here, the next process is the process for the next image among the processing for each image acquired by the image acquisition unit 11, such as processing for each frame of the video image acquired by the image acquisition unit 11.

The feature difference calculation unit 33 calculates noisy feature difference data. The noisy feature difference data is difference data between the feature data generated in each successive process and the noisy feature data generated in one previous process.

In processing the second and subsequent images, the transmission-side device 30 transmits to the reception-side device 40 a bitstream obtained by quantizing and encoding the noisy feature difference data instead of the feature data. The reception-side device 40 restores the noisy feature difference data from the received bitstream. Then, the reception-side device 40 calculates the noisy feature data for the current processing by adding the restored noisy feature difference data and the noisy feature data from the one previous processing. Subsequent processing is the same as in the case of the reception-side device 20 of the first example embodiment.

The reception-side device 40 corresponds to an example of an information processing device.

In the processing of the second and subsequent images, the feature calculation unit 34 of the transmission-side device 30 calculates the noisy feature data in the current processing by adding together the noisy feature difference data in the current processing calculated by the dequantization unit 32 and the noisy feature data in the previous processing stored by the noisy feature data storage unit 35. The feature calculation unit 34 updates the noisy feature data in the previous processing stored in the noisy feature data storage unit 35 to the noisy feature data in the current processing calculated by the feature calculation unit 34 itself. The updating of data here may be overwriting of data.

The noisy feature data storage unit 43 of the reception-side device 40 temporarily stores the noisy feature data similarly to the noisy feature data storage unit 35 of the transmission-side device 30.

The feature calculation unit 42 adds together the noisy feature difference data in the current processing restored by the dequantization unit 24 and the noisy feature data in the previous processing stored in the noisy feature data storage unit 43. Thereby, the feature calculation unit 42 calculates the noisy feature data in the current processing. The feature calculation unit 42 outputs the calculated noisy feature data to the intermediate feature generation unit 25. The feature calculation unit 42 updates the noisy feature data in the previous processing stored in the noisy feature data storage unit 43 to the noisy feature data in the current processing calculated by the feature calculation unit 42 itself.

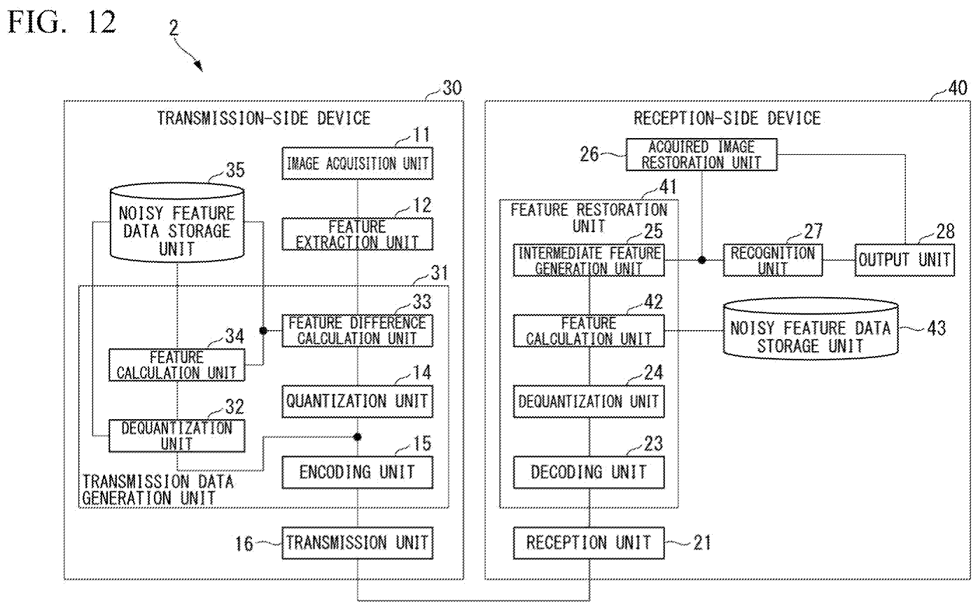

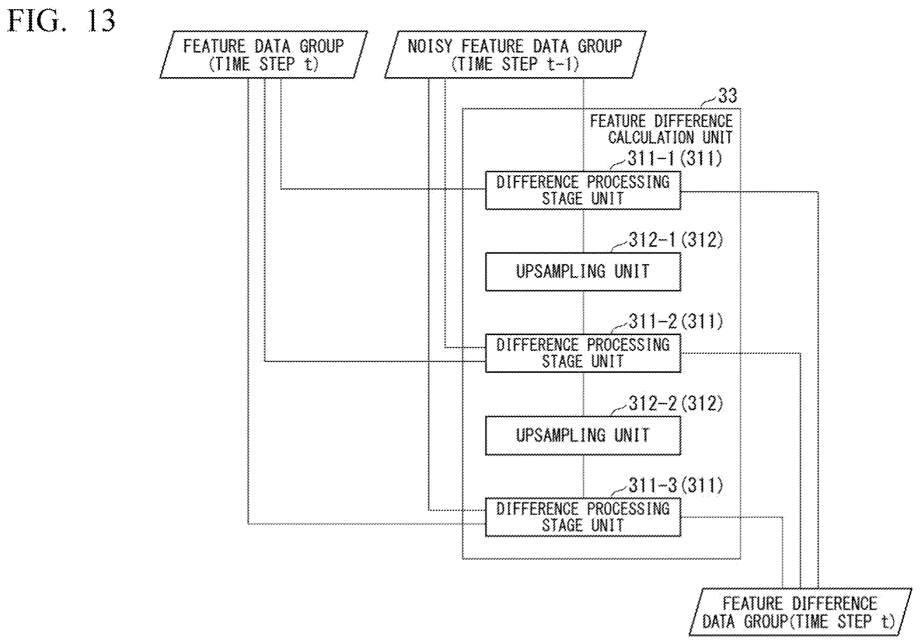

FIG. 13 is a schematic block diagram showing a configuration example of the feature difference calculation unit 33. In the configuration shown in FIG. 13, the feature difference calculation unit 33 is provided with a difference processing stage unit 311 and an upsampling unit 312.

FIG. 13 shows an example in which the feature difference calculation unit 33 is configured using an invertible deep convolutional neural network model. However, the configuration of the feature difference calculation unit 33 is not limited to a specific one.

In the example of FIG. 13, the feature difference calculation unit 33 is provided with three difference processing stage units 311 and two upsampling units 312. These are connected in series in an arrangement in which one upsampling unit 312 is provided between two difference processing stage units 311. When distinguishing the three difference processing stage units 311, reference numerals 311-1, 311-2, and 311-3 are attached in order from the upstream side to the downstream side of the data flow. When distinguishing between the two upsampling units 312, reference numerals 312-1 and 312-2 are assigned in order from the upstream side to the downstream side of the data flow.

Hereinbelow, the time step in the current process is denoted by time step t, and the time step in the previous process is denoted by time step t−1.

Each difference processing stage unit 311 calculates the difference between the feature data at time step t and the noisy feature data at time step t−1.

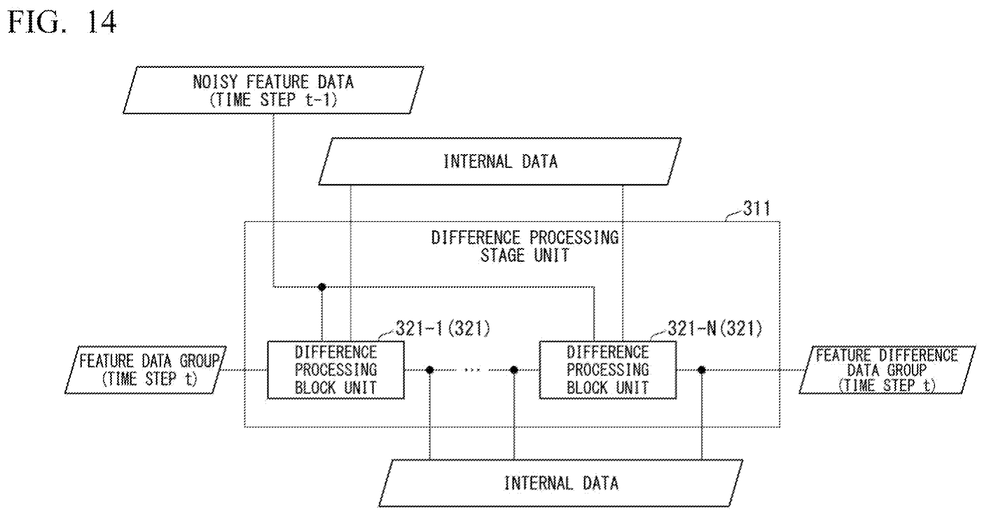

FIG. 14 is a schematic block diagram showing a configuration example of the difference processing stage unit 311. In the configuration shown in FIG. 14, the difference processing stage unit 311 is provided with a difference processing block unit 321.

In the example of FIG. 14, N difference processing block units 321 are connected in series. When distinguishing between the N difference processing block units 321, reference numerals 321-1, . . . , 321-N are attached in order from the upstream to the downstream of the data flow.

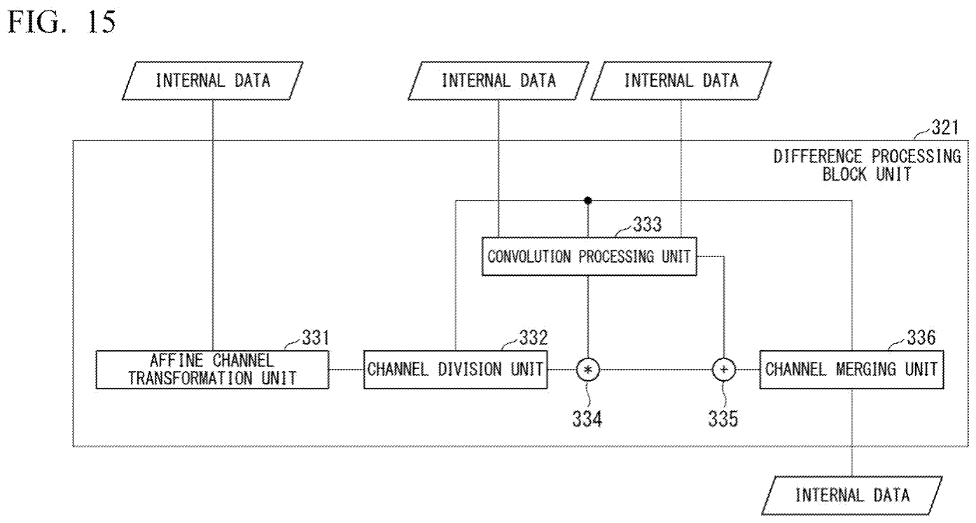

FIG. 15 is a schematic block diagram showing a configuration example of the difference processing block unit 321. In the configuration shown in FIG. 15, the difference processing block unit 321 is provided with an affine channel transformation unit 331, a channel division unit 332, a convolution processing unit 333, a multiplication unit 334, an addition unit 335, and a channel merging unit 336.

The affine channel transformation unit 331, the channel division unit 332, the multiplication unit 334, the addition unit 335, and the channel merging unit 336 correspond to the affine channel transformation unit 131, the channel division unit 132, the multiplication unit 134, the addition unit 135, and the channel merging unit 136. The affine channel transformation unit 331 performs the same processing as the affine channel transformation unit 131 on data from the other difference processing block units 321 or feature data from the feature extraction unit 12.

The convolution processing unit 333 receives the data from channel division unit 332, the noisy feature data at time step t−1, and the data from the upsampling unit 312.

The data from the channel division unit 332 to the convolution processing unit 333 is data of the group corresponding to group B. Also, the convolution processing unit 333 acquires the noisy feature data at time step t−1, which is stored by the noisy feature data storage unit 35.

The convolution processing unit 333 merges the data from the channel division unit 332, the noisy feature data at time step t−1, and the data from the upsampling unit 312, and performs the same processing on the merged data as the convolution processing unit 133.

Specifically, the convolution processing unit 333 performs convolution processing on the merged data. The convolution processing unit 333 may perform a series of processing such as convolution processing and nonlinear transformation on the merged data. The convolution processing unit 333 may be configured using a convolutional neural network.

Note that there is no input from the upsampling unit 312 in the difference processing stage unit 311-1. Therefore, in the difference processing block unit 321 of the difference processing stage unit 311-1, the convolution processing unit 333 may merge the data from the channel division unit 332 and the noisy feature data at time step t−1.

The convolution processing unit 333 assigns the processed data into two groups, a group corresponding to group C and a group corresponding to group D. The convolution processing unit 333 outputs the data assigned to the group corresponding to group C to the multiplication unit 334 and outputs the data assigned to the group corresponding to group D to the addition unit 335.

FIG. 16 is a schematic block diagram showing a configuration example of the feature calculation unit 34. In the configuration shown in FIG. 16, the feature calculation unit 34 is provided with a restoration processing stage unit 341 and an upsampling unit 342.

FIG. 16 shows an example in which the feature calculation unit 34 is configured using an invertible deep convolutional neural network model. However, the configuration of the feature calculation unit 34 is not limited to a specific one.

In the example of FIG. 16, the feature calculation unit 34 is provided with three restoration processing stage units 341 and two upsampling units 342. These are connected in series in an arrangement in which one upsampling unit 342 is provided between two restoration processing stage units 341. When distinguishing between the three restoration processing stage units 341, reference numerals 341-1, 341-2, and 341-3 are attached in order from the upstream side to the downstream side of the data flow. When distinguishing between the two upsampling units 342, reference numerals 342-1 and 342-2 are assigned in order from the upstream side to the downstream side of the data flow.

Each restoration processing stage unit 341 calculates noisy feature data at time step t based on the feature data at time step t−1 and the noisy feature difference data at time step t.

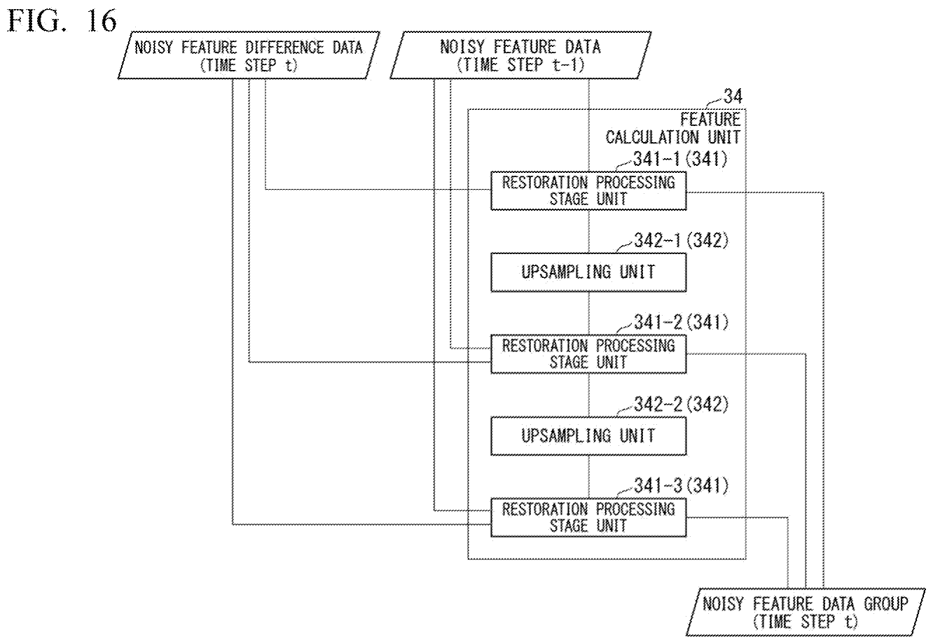

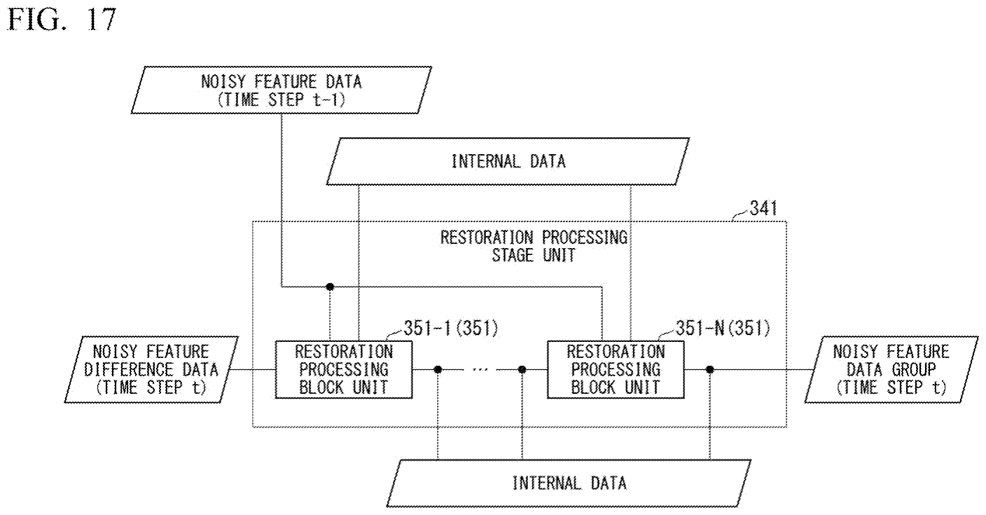

FIG. 17 is a schematic block diagram showing a configuration example of the restoration processing stage unit 341. In the configuration shown in FIG. 17, the restoration processing stage unit 341 is provided with restoration processing block units 351.

In the example of FIG. 17, N restoration processing block units 351 are connected in series. When distinguishing between the N restoration processing block units 351, reference numerals 351-1, . . . , 351-N are attached in order from the upstream side to the downstream side of the data flow.

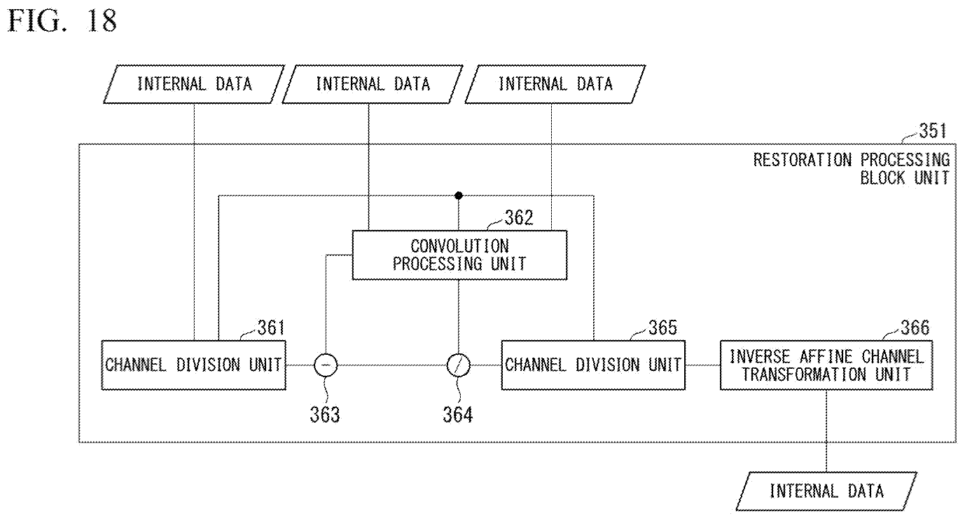

FIG. 18 is a schematic block diagram showing a configuration example of the restoration processing block unit 351. In the configuration shown in FIG. 18, the restoration processing block unit 351 is provided with a channel division unit 361, a convolution processing unit 362, a subtraction unit 363, a division unit 364, a channel merging unit 365, and an inverse affine channel transformation unit 366.

The channel division unit 361, the subtraction unit 363, the division unit 364, the channel merging unit 365, and the inverse affine channel transformation unit 366 are the same as the channel division unit 231, the subtraction unit 233, the division unit 234, the channel merging unit 235 and the inverse affine channel transformation unit 236 of the inverse processing block unit 221. The channel division unit 361 performs the same processing as the channel division unit 231 on the data from the other restoration processing block units 351 or the noisy feature difference data output from the dequantization unit 24.

The processing performed by the channel division unit 361 corresponds to the inverse processing of the processing performed by the channel merging unit 336. The operation performed by the subtraction unit 363 corresponds to the inverse operation of the operation performed by the addition unit 335. The operation performed by the division unit 364 corresponds to the inverse operation of the operation performed by the multiplication unit 334. The processing performed by the channel merging unit 365 corresponds to the inverse processing of the processing performed by the channel division unit 332.

The convolution processing unit 362 performs processing similar to that of the convolution processing unit 333. Specifically, the convolution processing unit 362 receives the input of the data from channel division unit 361, the noisy feature data at time step t−1, and the data from the upsampling unit 342.

The data from the channel division unit 361 to the convolution processing unit 362 is data of the group corresponding to group B. Also, the convolution processing unit 362 acquires the noisy feature data at time step t−1, which is stored by the noisy feature data storage unit 35.

The convolution processing unit 362 merges the data from the channel division unit 361, the noisy feature data at time step t−1, and the data from the upsampling unit 342, and performs the same processing on the merged data as the convolution processing unit 333.

Specifically, the convolution processing unit 362 performs convolution processing on the merged data. The convolution processing unit 362 may perform a series of processing such as convolution processing and nonlinear transformation on the merged data. The convolution processing unit 362 may be configured using a convolutional neural network.

The convolution processing unit 362 assigns the processed data to two groups, a group corresponding to group C and a group corresponding to group D. The convolution processing unit 362 outputs the data assigned to the group corresponding to group D to the subtraction unit 363 and outputs the data assigned to the group corresponding to group C to the division unit 364.

The feature restoration unit 41 of the reception-side device 40 restores the feature difference data based on the communication data received by the reception unit 21, and restores the feature data at time step t based on the restored feature difference data and the noisy feature data at time step t−1 stored by the noisy feature data storage unit 43.

The feature restoration unit 41 corresponds to an example of a feature restoration means.

In the second example embodiment, the transmission-side device 30 and the reception-side device 40 transmit and receive communication data indicating feature difference data, whereby the dequantization unit 24 dequantizes the quantized feature difference data.

As in the dequantization of the quantized feature data in the first example embodiment, the dequantization unit 24 performs dequantization based on sampling according to the probability distribution of feature difference data before the quantization. For example, the dequantization unit 24 may store in advance a probability distribution representing the encoding probability of real vectors as elements of feature difference data, and perform sampling based on this probability distribution.

The feature calculation unit 42 of the reception-side device 40 is the same as the feature calculation unit 34 of the transmission-side device 30. Similar processing is performed by the transmission-side device 30 and the reception-side device 40 to generate and store noisy feature data.

The transmission-side device 30 uses the noisy feature data stored in the noisy feature data storage unit 35 as the previous noisy feature data (time step t−1) for calculating the noisy feature difference data. When the reception-side device 40 restores the noisy feature data (time step t) from the noisy feature difference data, the previous noisy feature data (time step t−1) stored in the noisy feature data storage unit 43 is used.

It is expected that the reception-side device 40 will be able to restore the current noisy feature data with high accuracy by using the previous noisy feature data to restore the current noisy feature data, similar to the transmission-side device 30.

FIG. 19 is a flowchart showing an example of the processing procedure performed by the transmission-side device 30. FIG. 19 shows an example of the processing procedure on a single image when the transmission-side device 30 sends to the reception-side device 40 multiple images (frames in the case of a video image), such as video images or continuous still images. The transmission-side device 30 repeats the processing of FIG. 19 for each image.

Since the transmission of the first image and the transmission of the second and subsequent images are processed differently by the transmission-side device 30, the number of images to be transmitted and received is expressed as a time step. For example, when the transmission-side device 30 performs processing for transmitting the first image, the time step t=1.

In the process of FIG. 19, the image acquisition unit 11 acquires an image (Step S301). As described above, the image acquired by the image acquisition unit 11 is also referred to as an acquired image. Also, let the time step of the current process be time step t, where t is a positive integer.

Next, the feature extraction unit 12 extracts feature data of the acquired image (Step S302).

Next, the transmission-side device 30 determines whether or not the time step t is t=1 (Step S303). That is, the transmission-side device 30 determines whether the image to be transmitted is the first image.

If it is determined that t=1 (Step S303: YES), the quantization unit 14 quantizes the feature data (Step S311).

Next, the encoding unit 15 encodes the quantized data (Step S331). The “quantized data” referred to here is the feature data quantized in Step S311 when t=1. On the other hand, when t≥2, the “quantized data” is the differential data quantized in Step S322. The encoding unit 15 generates a transmission bitstream by encoding the quantized data.

Next, the transmission unit 16 transmits the bitstream generated by the encoding unit 15 to the reception-side device 40 (Step S332).

Next, the transmission-side device 30 determines whether or not the time step t is t=1 (Step S333). That is, the transmission-side device 30 determines whether the image transmitted in Step S332 is the first image.

If it is determined that t=1 (Step S333: YES), the dequantization unit 32 calculates noisy feature data by dequantizing the quantized data, and stores the noisy feature data in the noisy feature data storage unit 35 (Step S341). When t=1, the quantization unit 14 quantizes the feature data in Step S311. From this, the noisy feature data is obtained by dequantization in Step S341.

After Step S341, the transmission-side device 30 ends the processing of FIG. 19.

On the other hand, when the transmission-side device 30 determines that t≥2 in Step S303 (Step S303: NO), the feature difference calculation unit 33 calculates feature difference data (Step S321).

Specifically, the feature difference calculation unit 33 reads the noisy feature data stored in the noisy feature data storage unit 35. This noisy feature data is the noisy feature data at time step t−1, since it was obtained in the previous execution of the process in FIG. 19 by the transmission-side device 30.

Then, the feature difference calculation unit 33 calculates the feature difference data based on the feature data (time step t) extracted by the feature extraction unit 12 in Step S302 and the noisy feature data (time step t−1) read from the noisy feature data storage unit 35.

After Step S321, the quantization unit 14 quantizes the feature difference data (Step S322).

After Step S322, the process proceeds to Step S331.

On the other hand, if the transmission-side device 30 determines that t≥2 in Step S333 (Step S333: NO), the dequantization unit 32 calculates the noisy feature difference data by dequantizing the quantized data (Step S351). When t≥2, the quantization unit 14 quantizes the feature difference data in Step S322. From this, the noisy feature difference data is obtained by dequantization in Step S351.

After Step S351, the feature calculation unit 34 calculates noisy feature data and stores it in the noisy feature data storage unit 35 (Step S352).

Specifically, the feature calculation unit 34 reads the noisy feature data (time step t−1) stored in the noisy feature data storage unit 35. Then, the feature calculation unit 34 calculates the noisy feature data (time step t) based on the noisy feature difference data (time step t) calculated by the dequantization unit 32 in Step S351 and the noisy feature data (time step t−1) read from the noisy feature data storage unit 35. The feature calculation unit 34 stores the calculated noisy feature data (time step t) in the noisy feature data storage unit 35.

After Step S352, the transmission-side device 30 ends the processing of FIG. 19.

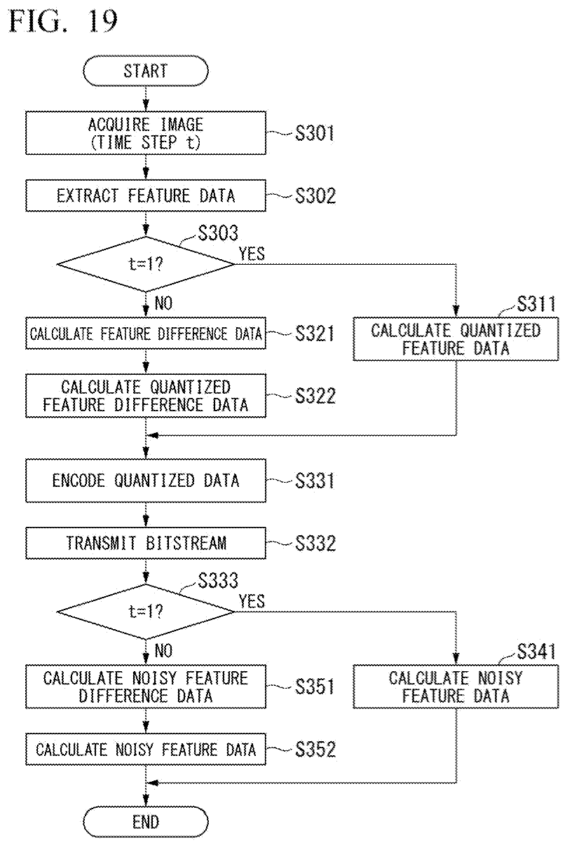

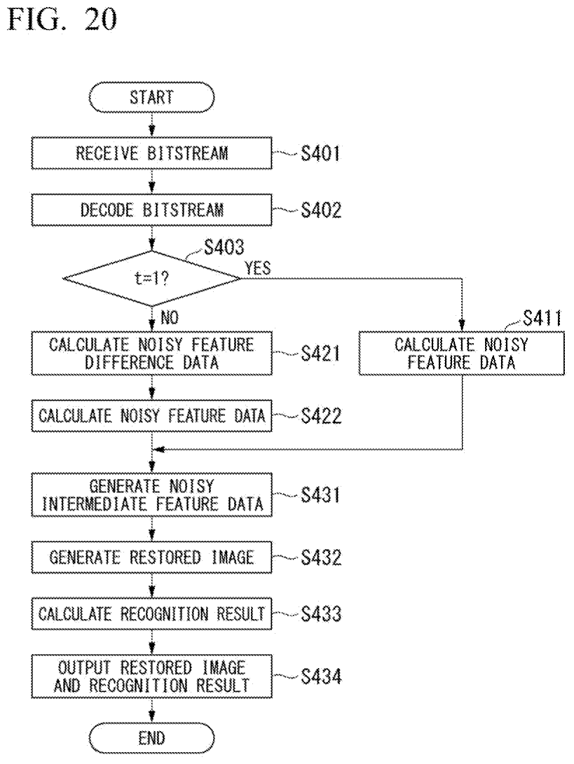

FIG. 20 is a flowchart showing an example of the processing procedure performed by the reception-side device 40. The reception-side device 40 repeats the processing in FIG. 20 in accordance with the repetition of the processing in FIG. 19 by the transmission-side device 30.

Steps S401 and S402 in FIG. 20 are the same as steps S201 and S202 in FIG. 11 except that the bitstream may represent feature data or feature difference data. In Step S402, when the time step t is t=1, quantized feature data is obtained. On the other hand, when t≥2, quantized feature difference data is obtained.

After Step S402, the reception-side device 40 determines whether the time step t is t=1 (Step S403). That is, the reception-side device 40 determines whether the image to be restored is the first image.

If the reception-side device 40 determines that t=1 (Step S403: YES), the dequantization unit 24 calculates the noisy feature data and stores it in the noisy feature data storage unit 43 (Step S411).

Specifically, the dequantization unit 24 calculates the noisy feature data by dequantizing the data obtained by decoding the bitstream, as in the case of Step S203 in FIG. 11. Then, the dequantization unit 24 stores the calculated noisy feature data in the noisy feature data storage unit 43.

After Step S411, the processing proceeds to Step S431.

Steps S431 to S434 are the same as steps S204 to S207 in FIG. 11.

After Step S434, the reception-side device 40 ends the processing of FIG. 20.

On the other hand, if the reception-side device 40 determines in Step S403 that t≥2 (Step S403: NO), the dequantization unit 24 calculates the noisy feature difference data by dequantizing the data obtained by decoding the bitstream in Step S402 (Step S421).

Next, the feature calculation unit 42 calculates noisy feature data (time step t) and stores it in the noisy feature data storage unit 43 (Step S422). Specifically, the feature calculation unit 42 reads the noisy feature data stored in the noisy feature data storage unit 43. This noisy feature data is the noisy feature data at time step t−1, since it was obtained in the previous execution of the process in FIG. 20 by the reception-side device 40.

Then, the feature calculation unit 42 calculates the noisy feature data (time step t) based on the noisy feature difference data (time step t) calculated by the dequantization unit 24 in Step S421 and the noisy feature data (time step t−1) read from the noisy feature data storage unit 35. The feature calculation unit 42 stores the calculated noisy feature data in the noisy feature data storage unit 43.

After Step S422, the processing proceeds to Step S431.

As described above, the reception unit 21 receives communication data based on feature difference data indicating the difference between the first feature data indicating the feature of the acquired image at the first time step and the second feature data indicating the feature of the acquired image at the second time step, which is a later time step than the first time step. The feature restoration unit 41 restores the feature difference data based on the received communication data, and restores the second feature data based on the restored feature difference data and the first feature data.

According to the reception-side device 40, by receiving communication data based on the feature difference data, it is expected that the amount of communication will be less than the case of receiving communication data based on the feature data.

The reception unit 21 also receives communication data based on the quantized difference data. The dequantization unit 24 performs dequantization on the quantized feature difference data based on sampling according to the probability distribution of the feature difference data before quantization.

It is expected that the dequantization unit 24 can perform dequantization with high accuracy by reflecting the probability distribution of the feature difference data in the dequantization.

### Third Example Embodiment

In the information processing system 1 or the information processing system 2, the setting of the processing performed by the transmission-side device may be dynamically updated, such as by dynamically changing the compression ratio of the communication data. At that time, the setting of the processing performed by the reception-side device may also be dynamically updated. This point will be described in the third example embodiment.

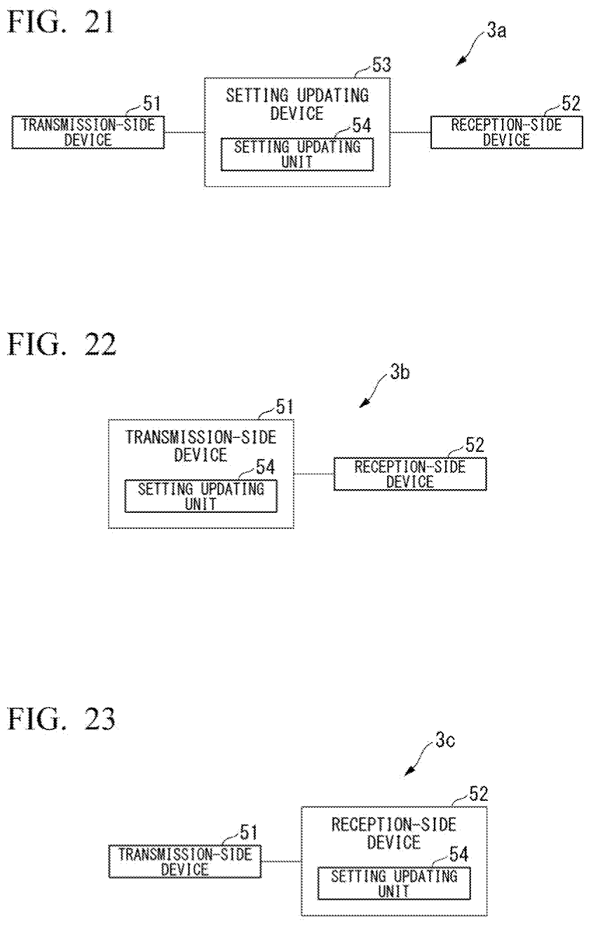

FIG. 21 is a schematic block diagram showing a first example of the configuration of the information processing system according to the third example embodiment. In the configuration shown in FIG. 21, the information processing system 3a is provided with a transmission-side device 51, a reception-side device 52, and a setting updating device 53. The setting updating device 53 is provided with a setting updating unit 54.

The transmission-side device 51 and the reception-side device 52 may be the transmission-side device 10 and the reception-side device 20. That is, the third example embodiment may be implemented based on the first example embodiment. Alternatively, the transmission-side device 51 and the reception-side device 52 may be the transmission-side device 30 and the reception-side device 40. That is, the third example embodiment may be implemented based on the second example embodiment.

The setting updating unit 54 updates the setting of the processing of the transmission-side device 51 and the setting of the processing of the reception-side device 52. For example, the setting updating unit 54 dynamically updates the settings of these processes so that the processing of the feature extraction unit 12, and the processing of the intermediate feature generation unit 25 and the acquired image restoration unit 26 have an inverse operation relationship. Further, for example, the setting updating unit 54 may dynamically change the number of processing stage units 112 of the feature extraction unit 12, and the number of the inverse processing stage units 211 of the intermediate feature generation unit 25 and the acquired image restoration unit 26 so that they are the same number.

The setting updating unit 54 corresponds to an example of a setting updating means.

As a result, it is expected that processing settings such as the compression ratio of communication data can be dynamically changed, and that the reception-side device 52 can restore feature data with high accuracy.

The setting updating unit 54 may be provided in either the transmission-side device or the reception-side device.

FIG. 22 is a schematic block diagram showing a second example of the configuration of the information processing system according to the third example embodiment. In the configuration shown in FIG. 22, in the information processing system 3b, the setting updating unit 54 is provided in the transmission-side device 51. In other respects, the information processing system 3b is the same as the information processing system 3a.

FIG. 23 is a schematic block diagram showing a third example of the configuration of the information processing system according to the third example embodiment. In the configuration shown in FIG. 23, in the information processing system 3c, the setting updating unit 54 is provided in the reception-side device 52. In other respects, the information processing system 3c is the same as the information processing system 3a.

### Fourth Example Embodiment

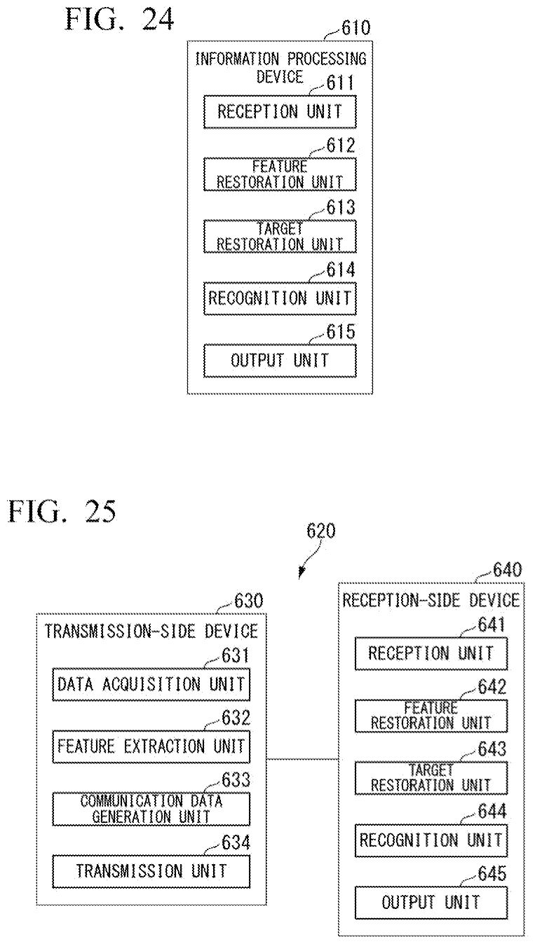

FIG. 24 is a schematic block diagram showing a configuration example of the information processing device according to the fourth example embodiment. In the configuration shown in FIG. 24, the information processing device 610 is provided with a reception unit 611, a feature restoration unit 612, a target restoration unit 613, a recognition unit 614, and an output unit 615.

In such a configuration, the reception unit 611 receives communication data based on feature data indicating features of the presented content of the target data. The feature restoration unit 612 restores the feature data based on the received communication data. The target restoration unit 613 restores the target data based on the restored feature data. The recognition unit 614 performs recognition processing on the presented content of the target data based on the restored feature data. The output unit 615 outputs information indicating the presented content of the restored target data and the recognition result of the recognition processing.

The reception unit 611 corresponds to an example of a reception means, and the feature restoration unit 612 corresponds to an example of a feature restoration means. The target restoration unit 613 corresponds to an example of a target restoration means. The recognition unit 614 corresponds to an example of a recognition means. The output unit 615 corresponds to an example of an output means.

In this way, the information processing device 610 uses the feature data restored by the feature restoration unit 612 for both restoration of target data by the target restoration unit 613 and recognition processing by the recognition unit 614. According to the information processing device 610, the processing time for the restoration processing of the target data and the recognition processing on the presented content of the restored target data can be shortened in comparison with the case where the target data is restored and then the recognition processing is performed using the restored target data.

### Fifth Example Embodiment

FIG. 25 is a schematic block diagram showing a configuration example of the information processing system according to the fifth example embodiment. In the configuration shown in FIG. 25, an information processing system 620 is provided with a transmission-side device 630 and a reception-side device 640. The transmission-side device 630 is provided with a data acquisition unit 631, a feature extraction unit 632, a communication data generation unit 633, and a transmission unit 634. The reception-side device 640 is provided with a reception unit 641, a feature restoration unit 642, a target restoration unit 643, a recognition unit 644, and an output unit 645.

In such a configuration, the data acquisition unit 631 acquires target data. The feature extraction unit 632 calculates feature data indicating the features of the presented content of the target data. The communication data generation unit 633 generates communication data based on the feature data. The transmission unit 634 transmits the communication data. The reception unit 641 receives the communication data. The feature restoration unit 642 restores the feature data based on the received communication data. The target restoration unit 643 restores the target data based on the restored feature data. The recognition unit 644 performs recognition processing on the presented content of the target data based on the restored feature data. The output unit 645 outputs information indicating the presented content of the restored target data and the recognition result of the recognition processing.

In this way, the reception-side device 640 uses the feature data restored by the feature restoration unit 642 for both restoration of target data by the target restoration unit 643 and recognition processing by the recognition unit 644. According to the information processing system 620, the processing time for the restoration processing of the target data and the recognition processing on the presented content of the restored target data can be shortened in comparison with the case where the target data is restored and then the recognition processing is performed using the restored target data.

### Sixth Example Embodiment

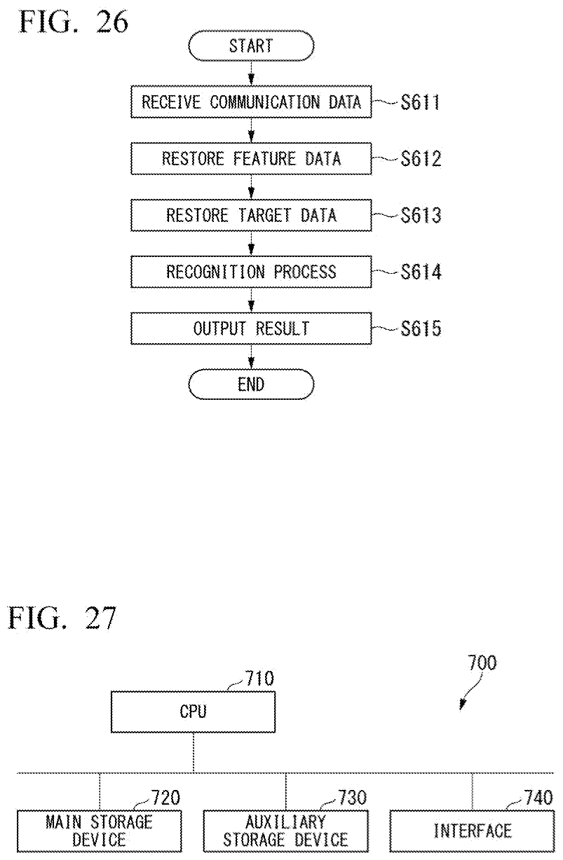

FIG. 26 is a flowchart showing an example of the processing procedure in the information processing method according to the sixth example embodiment. The processing shown in FIG. 26 includes acquiring communication data (Step S611), restoring feature data (Step S612), restoring target data (Step S613), performing recognition processing (Step S614), and outputting the result (Step S615).

In acquiring communication data (Step S611), communication data based on feature data indicating features of the presented content of target data is received. In restoring the feature data (Step S612), the feature data is restored based on the received communication data. In restoring the target data (Step S613), the target data is restored based on the restored feature data. In performing recognition processing (Step S614), recognition processing is performed on the presented content of the target data based on the restored feature data. In outputting the result (Step S615), information indicating the presented content of the restored target data and the recognition result of the recognition processing is output.

According to the information processing method shown in FIG. 26, the feature data restored in Step S612 is used for both the restoration of the target data in Step S613 and the recognition processing in Step S614. According to the information processing method shown in FIG. 26, the processing time for the restoration processing of the target data and the recognition processing on the presented content of the restored target data can be shortened in comparison with the case where the target data is restored and then the recognition processing is performed using the restored target data.

FIG. 27 is a schematic block diagram showing the configuration of a computer according to at least one example embodiment.

In the configuration shown in FIG. 27, a computer 700 is provided with a CPU (Central Processing Unit) 710, a main storage device 720, an auxiliary storage device 730, and an interface 740.

Any one or more of the transmission-side device 10, the reception-side device 20, the transmission-side device 30, the reception-side device 40, the transmission-side device 51, the reception-side device 52, the setting updating device 53, the information processing device 610, the transmission-side device 630, and the reception-side device 640 mentioned above or any part thereof may be implemented in the computer 700. In that case, the operation of each processing unit described above is stored in the auxiliary storage device 730 in the form of a program. The CPU 710 reads out the program from the auxiliary storage device 730, deploys the program in the main storage device 720, and executes the above processing according to the program. In addition, the CPU 710 secures storage areas corresponding to the storage units described above in the main storage device 720 according to the program. Communication between each device and another device is performed by the interface 740 having a communication function and performing communication under the control of the CPU 710.

When the transmission-side device 10 is implemented in the computer 700, the operations of the feature extraction unit 12, the communication data generation unit 13, and the respective units thereof are stored in the auxiliary storage device 730 in the form of a program. The CPU 710 reads out the program from the auxiliary storage device 730, deploys the program in the main storage device 720, and executes the above processing according to the program.

In addition, the CPU 710 secures in the main storage device 720 a storage area for the processing performed by the transmission-side device 10 according to the program.

Acquisition of image data by the image acquisition unit 11 is performed by, for example, the interface 740 being provided with an imaging device, and the imaging being executed according to the control of the CPU 710. Data transmission by the transmission unit 16 is executed by the interface 740 having a communication function and operating under the control of the CPU 710.

When the reception-side device 20 is implemented in the computer 700, the operations of the feature restoration unit 22, the acquired image restoration unit 26, the recognition unit 27, and the respective units thereof are stored in the auxiliary storage device 730 in the form of a program. The CPU 710 reads out the program from the auxiliary storage device 730, deploys the program in the main storage device 720, and executes the above processing according to the program.

In addition, the CPU 710 secures in the main storage device 720 a storage area for the processing performed by the reception-side device 20 according to the program.

Data reception by the reception unit 21 is executed by the interface 740 having a communication function and operating under the control of the CPU 710. Information is output by the output unit 28 by, for example, the interface 740 being provided with a display device and displaying an image under the control of the CPU 710.

When the transmission-side device 30 is implemented in the computer 700, the operations of the feature extraction unit 12, the communication data generation unit 31, and the respective units thereof are stored in the auxiliary storage device 730 in the form of a program. The CPU 710 reads out the program from the auxiliary storage device 730, deploys the program in the main storage device 720, and executes the above processing according to the program.

Further, the CPU 710 secures a storage area for processing of the transmission-side device 30 such as the noisy feature data storage unit 35 in the main storage device 720 according to the program.

Acquisition of image data by the image acquisition unit 11 is performed by, for example, the interface 740 being provided with an imaging device, and the imaging being executed according to the control of the CPU 710. Data transmission by the transmission unit 16 is executed by the interface 740 having a communication function and operating under the control of the CPU 710.

When the reception-side device 40 is implemented in the computer 700, the operations of the acquired image restoration unit 26, the recognition unit 27, the feature restoration unit 41, and the respective units thereof are stored in the auxiliary storage device 730 in the form of a program. The CPU 710 reads out the program from the auxiliary storage device 730, deploys the program in the main storage device 720, and executes the above processing according to the program.

Further, the CPU 710 secures a storage area for processing of the reception-side device 40 such as the noisy feature data storage unit 43 in the main storage device 720 according to the program.

Data reception by the reception unit 21 is executed by the interface 740 having a communication function and operating under the control of the CPU 710. Information is output by the output unit 28 by, for example, the interface 740 being provided with a display device and displaying an image under the control of the CPU 710.

When the information processing device 610 is implemented in the computer 700, the operations of the feature restoration unit 612, the target restoration unit 613, and the recognition unit 614 are stored in the auxiliary storage device 730 in the form of programs. The CPU 710 reads out the program from the auxiliary storage device 730, deploys the program in the main storage device 720, and executes the above processing according to the program.

In addition, the CPU 710 secures in the main storage device 720 a storage area for the processing performed by the information processing device 610 according to the program.

Data reception by the reception unit 611 is executed by the interface 740 having a communication function and operating under the control of the CPU 710. Information is output by the output unit 615 by, for example, the interface 740 being provided with a display device and displaying an image under the control of the CPU 710.

When the transmission-side device 630 is implemented in the computer 700, the operations of the feature extraction unit 632 and the communication data generation unit 633 are stored in the auxiliary storage device 730 in the form of a program. The CPU 710 reads out the program from the auxiliary storage device 730, deploys the program in the main storage device 720, and executes the above processing according to the program.

In addition, the CPU 710 secures in the main storage device 720 a storage area for the processing performed by the transmission-side device 630 according to the program.

Acquisition of target data by the data acquisition unit 631 is executed by the interface 740 being provided with a device for acquiring target data, such as an imaging device, and operating under the control of the CPU 710. Data transmission by the transmission unit 634 is executed by the interface 740 having a communication function and operating under the control of the CPU 710.

When the reception-side device 640 is implemented in the computer 700, the operations of the feature restoration unit 642, the target restoration unit 643, and the recognition unit 644 are stored in the form of a program in the auxiliary storage device 730. The CPU 710 reads out the program from the auxiliary storage device 730, deploys the program in the main storage device 720, and executes the above processing according to the program.

In addition, the CPU 710 secures in the main storage device 720 a storage area for the processing performed by the reception-side device 640 according to the program.

Data reception by the reception unit 641 is executed by the interface 740 having a communication function and operating under the control of the CPU 710. Information is output by the output unit 645 by, for example, the interface 740 being provided with a display device and displaying an image under the control of the CPU 710.

A program for executing all or part of the processing performed by transmission-side device 10, the reception-side device 20, the transmission-side device 30, the reception-side device 40, the transmission-side device 51, the reception-side device 52, the setting updating device 53, the information processing device 610, the transmission-side device 630, and the reception-side device 640 may be recorded on a computer-readable recording medium, and the program recorded on this recording medium may be read into a computer system and executed, whereby the processing of each unit may be performed. It should be noted that the “computer system” referred to here includes an operating system and hardware such as peripheral devices.

In addition, the “computer-readable recording medium” refers to portable media such as flexible discs, magneto-optical discs, ROMs (Read Only Memories), CD-ROMs (Compact Disc Read Only Memories), and storage devices such as hard disks built into computer systems. Further, the program may be for realizing some of the functions described above, or may be capable of realizing the functions described above in combination with a program already recorded in the computer system.

Although example embodiments of the present invention have been described in detail with reference to the drawings, the specific configuration is not limited to these example embodiments, and designs and the like are included within the scope of the gist of the present invention.

Some or all of the above-described example embodiments can also be described as in the following supplementary notes, but are not limited thereto.

(Supplementary Note 1)

An information processing device comprising:
reception means that receives communication data based on feature data that indicates a feature of presented content of target data;
feature restoration means that restores the feature data on the basis of the received communication data;
target restoration means that restores the target data on the basis of the restored feature data;
recognition means that performs a recognition process on the presented content of the target data on the basis of the restored feature data; and
output means that outputs information that indicates the presented content of the restored target data and a recognition result of the recognition process.

(Supplementary Note 2)

The information processing device according to Supplementary Note 1, wherein the reception means receives the communication data based on the quantized feature data, and
the feature restoration means comprises dequantization means that dequantizes the feature data that has been quantized based on sampling according to a probability distribution of the feature data before quantization.

(Supplementary Note 3)

The information processing device according to Supplementary Note 1, wherein the reception means receives the communication data based on feature difference data indicating difference between first feature data indicating a feature of presented content of first target data at a first time step, and second feature data indicating a feature of presented content of second target data at a second time step that is a later time step than the first time step; and
the feature restoration means restores the feature difference data based on the received communication data, and restores the second feature data based on the restored feature difference data and the first feature data.

(Supplementary Note 4)

The information processing device according to Supplementary Note 3, wherein the reception means receives the communication data based on the feature difference data that has been quantized, and
the feature restoration means comprises dequantization means that dequantizes the quantized feature difference data based on sampling according to a probability distribution of the feature difference data before quantization.

(Supplementary Note 5)

The information processing device according to any one of Supplementary Notes 1 to 4, wherein the reception means receives the communication data based on the feature data including first intermediate feature data and second intermediate feature data calculated based on data downsampled from the first intermediate feature data, and
the feature restoration means restores the first intermediate feature data based on data upsampled from the second intermediate feature data restored based on the received communication data.

(Supplementary Note 6)

The information processing device according to Supplementary Note 5, wherein the feature restoration means restores the first intermediate feature data using a process corresponding to the inverse operation of the process of calculating the second intermediate feature data based on data downsampled from the first intermediate feature data.

(Supplementary Note 7)

The information processing device according to Supplementary Note 6, further comprising setting updating means that dynamically updates at least one of the setting of the process to be performed by the device from which the communication data is transmitted, the setting of the process to be performed by the feature restoration means, or the setting of the process to be performed by the target restoration means, so that the combination of the process of the feature restoration means and the process of the target restoration means is a process that corresponds to the inverse operation of the feature extraction process from the target data in the device from which the communication data is transmitted.

(Supplementary Note 8)

An information processing system comprising:
a transmission-side device and a reception-side device,
wherein the transmission-side device comprises:
data acquisition means that acquires target data;
feature extraction means that calculates feature data indicating a feature of presented content of the target data;
communication data generation means that generates communication data based on the feature data; and
transmission means that transmits the communication data;
and the reception-side device comprises:
reception means that receives the communication data;
feature restoration means that restores the feature data on the basis of the received communication data;
target restoration means that restores the target data on the basis of the restored feature data;
recognition means that performs a recognition process on the presented content of the target data on the basis of the restored feature data; and
output means that outputs information that indicates the presented content of the restored target data and a recognition result of the recognition process.

(Supplementary Note 9)

The information processing system according to Supplementary Note 8, wherein the communication data generation means comprises quantization means that quantizes the feature data, and
the feature restoration means comprises dequantization means that dequantizes the quantized feature data based on sampling according to a probability distribution of the feature data before quantization.

(Supplementary Note 10)

The information processing system according to Supplementary Note 8, wherein the data acquisition means acquires first target data at a first time step and second target data at a second time step that is a time step later than the first time step;
the feature extraction means calculates first feature data indicating a feature of presented content of the first target data and second feature data indicating a feature of presented content of the second target data;
the communication data generation means calculates feature difference data indicating the difference between the first feature data and the second feature data, and generates the communication data based on the calculated feature difference data; and
the feature restoration means restores the feature difference data based on the received communication data, and restores the second feature data based on the restored feature difference data and the first feature data.

(Supplementary Note 11)

The information processing system according to Supplementary Note 10, wherein the communication data generation means comprises quantization means that quantizes the feature difference data, and
the feature restoration means comprises dequantization means that dequantizes the quantized feature difference data based on sampling according to a probability distribution of the feature difference data before quantization.

(Supplementary Note 12)

The information processing system according to Supplementary Note 11, wherein the transmission-side device is further comprising:
noisy feature data storage means that stores noisy feature data, which is the feature data including a quantization error; and
the communication data generation means comprises:
feature difference calculation means that reads first noisy feature data, which is the first feature data including a quantization error, from the noisy feature data storage means, and calculates the feature difference data indicating the difference between the first noisy feature data and the second feature data, and
feature restoration means that calculates second noisy feature data, which is the second feature data including a quantization error, and updates the noisy feature data stored in the noisy feature data storage means to the second noisy feature data, based on data dequantized after the feature difference data indicating the difference between the first noisy feature data and the second feature data and the first noisy feature data is quantized and the first noisy feature data.

(Supplementary Note 13)

The information processing system according to any one of Supplementary Notes 8 to 12, wherein the feature extraction means calculates the feature data including first intermediate feature data and second intermediate feature data calculated based on data downsampled from the first intermediate feature data, and
the feature restoration means restores the first intermediate feature data based on data upsampled from the second intermediate feature data restored based on the received communication data.

(Supplementary Note 14)

The information processing system according to Supplementary Note 13, wherein the feature restoration means restores the first intermediate feature data using a process corresponding to the inverse operation of the process in which the feature extraction means calculates the second intermediate feature data based on data downsampled from the first intermediate feature data.

(Supplementary Note 15)

The information processing system according to Supplementary Note 14, further comprising setting updating means that dynamically updates at least one of the setting of the process to be performed by the device from which the communication data is transmitted, the setting of the process to be performed by the feature restoration method, or the setting of the process to be performed by the target restoration method, so that the combination of the process of the feature restoration means and the process of the target restoration means is a process that corresponds to the inverse operation of the feature extraction process from the target data in the device from which the communication data is transmitted.

(Supplementary Note 16)

An information processing method comprising:
receiving communication data based on feature data that indicates a feature of presented content of target data;
restoring the feature data on the basis of the received communication data;
restoring the target data on the basis of the restored feature data;
performing a recognition process on the presented content of the target data on the basis of the restored feature data; and
outputting information that indicates the presented content of the restored target data and a recognition result of the recognition process.

(Supplementary Note 17)

An information processing method comprising:
a transmission-side device acquiring target data;
the transmission-side device calculating feature data indicating a feature of presented content of the target data;
the transmission-side device generating communication data on the basis of the feature data;
the transmission-side device generating communication data on the basis of the feature data;
a reception-side device receiving the communication data;
the reception-side device restoring the feature data on the basis of the received communication data;
the reception-side device restoring the target data on the basis of the restored feature data;
the reception-side device performing a recognition process on the presented content of the target data on the basis of the restored feature data; and
the reception-side device outputting information that indicates the presented content of the restored target data and a recognition result of the recognition process.

(Supplementary Note 18)

A recording medium that records a program for causing a computer to execute:
receiving communication data based on feature data that indicates a feature of presented content of target data;
restoring the feature data on the basis of the received communication data;
restoring the target data on the basis of the restored feature data;
performing a recognition process on the presented content of the target data on the basis of the restored feature data; and
outputting information that indicates the presented content of the restored target data and a recognition result of the recognition process.

### INDUSTRIAL APPLICABILITY

The present invention may be applied to an information processing device, an information processing system, an information processing method, and a recording medium.

### DESCRIPTION OF REFERENCE SIGNS

1, 2, 620 Information processing system
10, 30, 630 Transmission-side device
11 Image acquisition unit
12, 632 Feature extraction unit
13, 31, 633 Communication data generation unit
14 Quantization unit
15 Encoding unit
16, 634 Transmission unit
20, 40, 640 Reception-side device
21, 611, 641 Reception unit
22, 41, 612, 642 Feature restoration unit
23 Decoding unit
24, 32 Dequantization unit
25 Intermediate feature generation unit
26 Acquired image restoration unit
27, 614, 644 Recognition unit
28, 615, 645 Output unit
33 Feature difference calculation unit
34, 42 Feature calculation unit
35, 43 Noisy feature data storage unit
111 Pre-processing unit
112 Processing stage unit
113, 132 231 Channel division unit
121 Downsampling unit
122 Processing block unit
131 Affine channel transformation unit
133, 232, 362 Convolution processing unit
134 Multiplication unit
135, 253 Addition unit
136, 212, 235, 365 Channel merging unit
211 Inverse processing stage unit
221 Inverse processing block unit
222, 252, 312, 342 Upsampling unit
233, 363 Subtraction unit
234, 364 Division unit
236 Inverse affine channel transformation unit
241 Post-processing unit
251 Intermediate feature processing unit
254 Position estimation processing unit
255 Classification processing unit
311 Difference processing stage unit
341 Restoration processing stage unit
351 Restoration processing block unit
610 Information processing device
613, 643 Target restoration unit
631 Data acquisition unit

What is claimed is:

1. An information processing device comprising:
a memory configured to store instructions; and
a processor configured to execute the instructions to:
receive communication data based on feature data that indicates a feature of presented content of target data;
restore the feature data on the basis of the received communication data;
restore the target data on the basis of the restored feature data;
perform a recognition process on the presented content of the target data on the basis of the restored feature data; and
output information that indicates the presented content of the restored target data and a recognition result of the recognition process.

2. The information processing device according to claim 1, wherein receiving comprises receiving the communication data based on the quantized feature data, and
the processor is further configured to execute the instruction to dequantize the feature data that has been quantized based on sampling according to a probability distribution of the feature data before quantization.

3. The information processing device according to claim 1, wherein receiving comprises receiving the communication data based on feature difference data indicating difference between first feature data indicating a feature of presented content of first target data at a first time step, and second feature data indicating a feature of presented content of second target data at a second time step that is a later time step than the first time step; and
restoring the feature data comprises restoring the feature difference data based on the received communication data, and restoring the second feature data based on the restored feature difference data and the first feature data.

4. The information processing device according to claim 3, wherein receiving comprises receiving the communication data feature difference data that has been quantized, and
the processor is further configured to execute the instruction to dequantize the quantized feature difference data based on sampling according to a probability distribution of the feature difference data before quantization.

5. The information processing device according to claim 1, wherein receiving comprises receiving the communication data based on the feature data including first intermediate feature data and second intermediate feature data calculated based on data downsampled from the first intermediate feature data, and
restoring the feature data comprises restoring the first intermediate feature data based on data upsampled from the second intermediate feature data restored based on the received communication data.

6. The information processing device according to claim 5, wherein restoring the feature data comprises restoring the first intermediate feature data using a process corresponding to the inverse operation of the process of calculating the second intermediate feature data based on data downsampled from the first intermediate feature data.

7. The information processing device according to claim 6, wherein the processor is further configured to execute the instruction to dynamically update at least one of the setting of the process to be performed by a device from which the communication data is transmitted, the setting of the process to restore the feature data, or the setting of the process to restore the target data, so that the combination of the process to restore the feature data and the process to restore the target data is a process that corresponds to the inverse operation of the feature extraction process from the target data in the device from which the communication data is transmitted.

8. (canceled)

9. An information processing method comprising:
receiving communication data based on feature data that indicates a feature of presented content of target data;
restoring the feature data on the basis of the received communication data;
restoring the target data on the basis of the restored feature data;
performing a recognition process on the presented content of the target data on the basis of the restored feature data; and
outputting information that indicates the presented content of the restored target data and a recognition result of the recognition process.

10. A non-transitory recording medium that records a program for causing a computer to execute:
receiving communication data based on feature data that indicates a feature of presented content of target data;
restoring the feature data on the basis of the received communication data;
restoring the target data on the basis of the restored feature data;
performing a recognition process on the presented content of the target data on the basis of the restored feature data; and
outputting information that indicates the presented content of the restored target data and a recognition result of the recognition process.
